(19) United States
(12) Patent Application Publication
(10) Pub. No.: US 2019/0097850 A1
(43) Pub. Date: Mar. 28, 2019

(54) PREAMBLE DESIGN FOR EXTREMELY HIGH THROUGHPUT WIRELESS COMMUNICATION WITH BACKWARD COMPATIBILITY

(71) Applicants: Thomas Kenney, Portland, OR (US); Qinghua Li, San Ramon, CA (US); Feng Jiang, Sunnyvale, CA (US); Xiaogang Chen, Portland, OR (US)

(72) Inventors: Thomas Kenney, Portland, OR (US); Qinghua Li, San Ramon, CA (US); Feng Jiang, Sunnyvale, CA (US); Xiaogang Chen, Portland, OR (US)

(21) Appl. No.: 16/206,224

(22) Filed: Nov. 30, 2018

(51) Int. Cl. H04L 27/00; H04L 27/22; H04L 27/20; H04L 27/26; H04L 1/00

(52) U.S. Cl. CPC H04L 27/0012; H04L 27/22; H04W 80/08; H04L 27/2613; H04L 1/0061; H04L 27/20

(57) ABSTRACT

A wireless communication device of a first Extremely High Throughput (EHT) wireless station (STA). The device comprises physical layer (PHY layer) circuitry and Medium Access Control layer (MAC) layer circuitry connected to the PHY layer circuitry. The PHY layer circuitry includes logic to encode a physical Layer Convergence Procedure (PLCP) Protocol Data Unit (PPDU), the PPDU being an EHT PPDU including a legacy preamble portion, an EHT preamble portion, and a data portion following the EHT preamble portion, the EHT preamble portion including: a first signal (SIG) field configured such that a second EHT station (STA) processing the first SIG field is to identify the PPDU as an EHT PPDU based on the first SIG field; and a second SIG field following the first SIG field, the second SIG field corresponding to an EHT signal (SIG) field. The PHY layer circuitry is further to cause transmission of the EHT PPDU to the second EHT STA.

### TECHNICAL FIELD

Embodiments pertain to wireless networks and wireless communications. Some embodiments relate to wireless local area networks (WLANs) and Wi-Fi networks including networks operating in accordance with the IEEE 802.11 family of standards. Some embodiments relate to IEEE 802.11ax, and/or IEEE 802.11 extremely high-throughput (EHT).

### BACKGROUND

Efficient use of the resources of a wireless local-area network (WLAN) is important to provide bandwidth and acceptable response times to the users of the WLAN. However, often there are many devices trying to share the same resources and some devices may be limited by the communication protocol they use or by their hardware bandwidth. Moreover, wireless devices may need to operate with both newer protocols and with legacy device protocols.

### BRIEF DESCRIPTION OF THE DRAWINGS

The present disclosure is illustrated by way of example and not limitation in the figures of the accompanying drawings, in which like references indicate similar elements and in which:

FIG. 1 is a block diagram of a radio architecture in accordance with some embodiments;

FIG. 2 illustrates a front-end module circuitry for use in the radio architecture of FIG. 1 in accordance with some embodiments;

FIG. 3 illustrates a radio IC circuitry for use in the radio architecture of FIG. 1 in accordance with some embodiments;

FIG. 4 illustrates a baseband processing circuitry for use in the radio architecture of FIG. 1 in accordance with some embodiments;

FIG. 5 illustrates a WLAN in accordance with some embodiments;

FIG. 6 illustrates a block diagram of an example machine upon which any one or more of the techniques (e.g., methodologies) discussed herein may perform;

FIG. 7 illustrates a block diagram of an example wireless device upon which any one or more of the techniques (e.g., methodologies or operations) discussed herein may perform;

FIG. 8 illustrates an extremely high throughput (EHT) physical Layer Convergence Procedure (PLCP) Protocol Data Unit (PPDU) configuration according to a first embodiment;

FIG. 9 illustrates the PPDU of FIG. 8, and further a flow chart showing processing of the PPDU by both legacy and EHT stations (STAB);

FIG. 10 illustrates an extremely high throughput (EHT) physical Layer Convergence Procedure (PLCP) Protocol Data Unit (PPDU) configuration according to a second embodiment;

FIG. 11 illustrates an extremely high throughput (EHT) physical Layer Convergence Procedure (PLCP) Protocol Data Unit (PPDU) configuration according to a third embodiment;

FIG. 12 illustrates a detailed flowchart showing processing outcomes for a processing of the EHT PPDU of FIG. 9;

FIG. 13 illustrates a detailed flowchart showing processing outcomes for a processing of the EHT PPDU of FIG. 11;

FIG. 14 illustrates a detailed flowchart showing processing outcomes for a processing of the EHT PPDU of FIG. 12;

FIG. 15 illustrates a method of generating a EHT PPDU in accordance with a first embodiment; and

FIG. 16 illustrates a method of generating a EHT PPDU in accordance with a second embodiment.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Some embodiments relate to methods, computer readable media, and apparatus for ordering or scheduling null data packet (NDP) feedback reports, traffic indication maps (TIMs), and other information during SPs. Some embodiments relate to methods, computer readable media, and apparatus for extending TIMs. Some embodiments relate to methods, computer readable media, and apparatus for defining SPs during beacon intervals (BI), which may be based on TWTs.

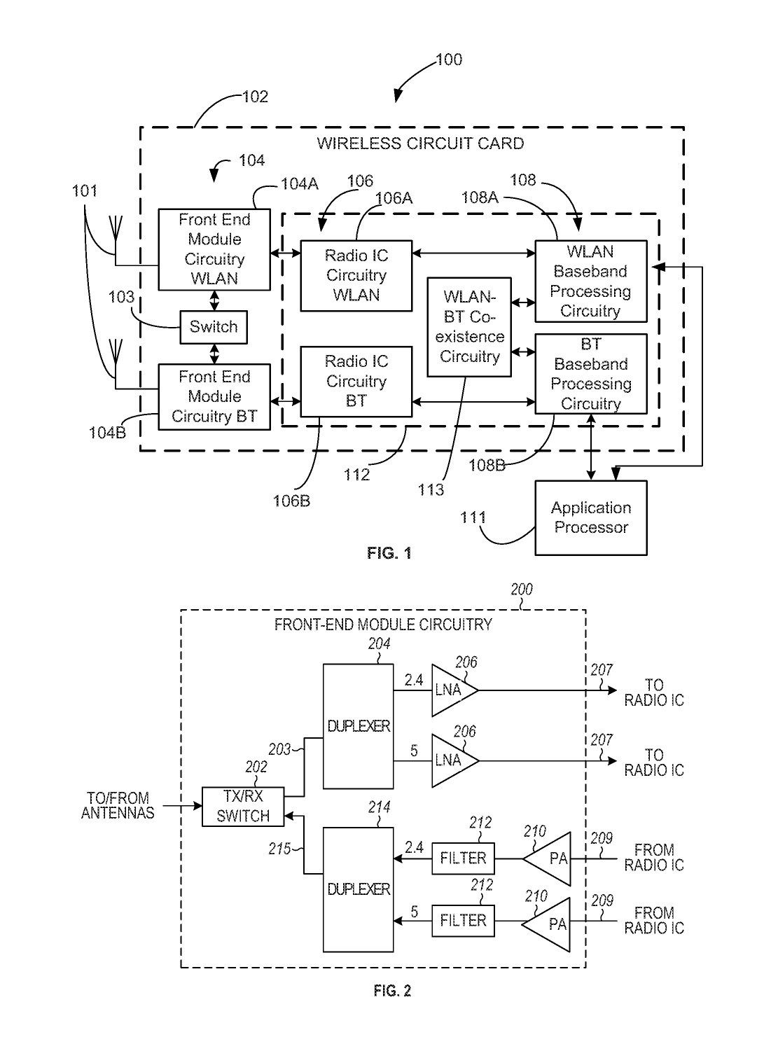

FIG. 1 is a block diagram of a radio architecture/wireless system 100 in accordance with some embodiments. Wireless system 100 may include radio front-end module (FEM) circuitry 104, radio IC circuitry 106 and baseband processing circuitry 108. Wireless system 100 as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 104 may include a WLAN or Wi-Fi FEM circuitry 104A and a Bluetooth (BT) FEM circuitry 104B. The WLAN FEM circuitry 104A may include a receive signal path comprising circuitry configured to operate on WLAN RF signals received from one or more antennas 101, to amplify the received signals and to provide the amplified versions of the received signals to the WLAN radio IC circuitry 106A for further processing. The BT FEM circuitry 104B may include a receive signal path which may include circuitry configured to operate on BT RF signals received from one or more antennas 101, to amplify the received signals and to provide the amplified versions of the received signals to the BT radio IC circuitry 106B for further processing. FEM circuitry 104A may also include a transmit signal path which may include circuitry configured to amplify WLAN signals provided by the radio IC circuitry 106A for wireless transmission by one or more of the antennas 101. In addition, FEM circuitry 104B may also include a transmit signal path which may include circuitry configured to amplify BT signals provided by the radio IC circuitry 106B for wireless transmission by the one or more antennas. In the embodiment of FIG. 1, although FEM 104A and FEM 104B are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 106 as shown may include WLAN radio IC circuitry 106A and BT radio IC circuitry 106B. The WLAN radio IC circuitry 106A may include a receive signal path which may include circuitry to down-convert WLAN RF signals received from the FEM circuitry 104A and provide baseband signals to WLAN baseband processing circuitry 108A. BT radio IC circuitry 106B may in turn include a receive signal path which may include circuitry to down-convert BT RF signals received from the FEM circuitry 104B and provide baseband signals to BT baseband processing circuitry 108B. WLAN radio IC circuitry 106A may also include a transmit signal path which may include circuitry to up-convert WLAN baseband signals provided by the WLAN baseband processing circuitry 108A and provide WLAN RF output signals to the FEM circuitry 104A for subsequent wireless transmission by the one or more antennas 101. BT radio IC circuitry 106B may also include a transmit signal path which may include circuitry to up-convert BT baseband signals provided by the BT baseband processing circuitry 108B and provide BT RF output signals to the FEM circuitry 104B for subsequent wireless transmission by the one or more antennas 101. In the embodiment of FIG. 1, although radio IC circuitries 106A and 106B are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuity 108 may include a WLAN baseband processing circuitry 108A and a BT baseband processing circuitry 108B. The WLAN baseband processing circuitry 108A may include a memory, such as, for example, a set of RAM arrays in a Fast Fourier Transform or Inverse Fast Fourier Transform block (not shown) of the WLAN baseband processing circuitry 108A. Each of the WLAN baseband circuitry 108A and the BT baseband circuitry 108B may further include one or more processors and control logic to process the signals received from the corresponding WLAN or BT receive signal path of the radio IC circuitry 106, and to also generate corresponding WLAN or BT baseband signals for the transmit signal path of the radio IC circuitry 106. Each of the baseband processing circuitries 108A and 108B may further include respective physical layer (PHY) and medium access control layer (MAC) circuitries, and may further interface with application processor 111 for generation and processing of the baseband signals and for controlling operations of the radio IC circuitry 106 including higher layer MAC functionalities.

Referring still to FIG. 1, according to the shown embodiment, WLAN-BT coexistence circuitry 113 may include logic providing an interface between the WLAN baseband circuitry 108A and the BT baseband circuitry 108B to enable use cases requiring WLAN and BT coexistence. In addition, a switch 103 may be provided between the WLAN FEM circuitry 104A and the BT FEM circuitry 104B to allow switching between the WLAN and BT radios according to application needs. In addition, although the antennas 101 are depicted as being respectively connected to the WLAN FEM circuitry 104A and the BT FEM circuitry 104B, embodiments include within their scope the sharing of one or more antennas as between the WLAN and BT FEMs, or the provision of more than one antenna connected to each of FEM 104A or 104B.

In some embodiments, the front-end module circuitry 104, the radio IC circuitry 106, and baseband processing circuitry 108 may be provided on a single radio card, such as wireless radio card 102. In some other embodiments, the one or more antennas 101, the FEM circuitry 104 and the radio IC circuitry 106 may be provided on a single radio card. In some other embodiments, the radio IC circuitry 106 and the baseband processing circuitry 108 may be provided on a single chip or IC, such as IC 112.

In some embodiments, the wireless radio card 102 may include a WLAN radio card and may be configured for Wi-Fi communications, although the scope of the embodiments is not limited in this respect. In some of these embodiments, the wireless system 100 may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, wireless system 100 may be part of a Wi-Fi communication station (STA) such as a wireless access point (AP) or a non-AP STA, a base station or a mobile device including a Wi-Fi device. In some of these embodiments, wireless system 100 may be configured to transmit and receive signals in accordance with specific communication standards and/or protocols, such as any of the Institute of Electrical and Electronics Engineers (IEEE) standards including, IEEE 802.11n-2009, IEEE 802.11-2012, IEEE 802.11-2016, IEEE 802.11ac, and/or IEEE 802.11ax standards and/or proposed specifications for WLANs, although the scope of embodiments is not limited in this respect. Wireless system 100 may also be suitable to transmit and/or receive communications in accordance with other techniques and standards.

In some embodiments, the wireless system 100 may be configured for high-efficiency (HE) Wi-Fi (HEW) communications in accordance with the IEEE 802.11ax standard. In these embodiments, the wireless system 100 may be configured to communicate in accordance with an OFDMA technique, although the scope of the embodiments is not limited in this respect.

In some embodiments, the wireless system 100 may be configured for extremely high throughput (EHT) communications in accordance with the next generation of the IEEE 802.11 standard subsequent to 802.11ax. The wireless system 100 may be configured to communicate in accordance with an OFDMA technique, although the scope of the embodiments is not limited in this respect.

In some other embodiments, the wireless system 100 may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 1, the BT baseband circuitry 108B may be compliant with a Bluetooth (BT) connectivity standard such as Bluetooth, Bluetooth 4.0 or Bluetooth 5.0, or any other iteration of the Bluetooth Standard. In embodiments that include BT functionality as shown for example in FIG. 1, the wireless system 100 may be configured to establish a BT synchronous connection oriented (SCO) link and/or a BT low energy (BT LE) link. In some of the embodiments that include functionality, the wireless system 100 may be configured to establish an extended SCO (eSCO) link for BT communications, although the scope of the embodiments is not limited in this respect. In some of these embodiments that include a BT functionality, the radio architecture may be configured to engage in a BT Asynchronous Connection-Less (ACL) communications, although the scope of the embodiments is not limited in this respect. In some embodiments, as shown in FIG. 1, the functions of a BT radio card and WLAN radio card may be combined on a single wireless radio card, such as single wireless radio card 102, although embodiments are not so limited, and include within their scope discrete WLAN and BT radio cards

In some embodiments, the wireless system 100 may include other radio cards, such as a cellular radio card configured for cellular (e.g., 3GPP such as LTE, LTE-Advanced or 5G communications).

In some IEEE 802.11 embodiments, the wireless system 100 may be configured for communication over various channel bandwidths including bandwidths having center frequencies of about 900 MHz, 2.4 GHz, 5 GHz, 6 GHz, and bandwidths of about 1 MHz, 2 MHz, 2.5 MHz, 4 MHz, 5 MHz, 8 MHz, 10 MHz, 16 MHz, 20 MHz, 40 MHz, 80 MHz (with contiguous bandwidths) or 80+80 MHz (160 MHz) (with non-contiguous bandwidths). In some embodiments, a 320 MHz channel bandwidth may be used. The scope of the embodiments is not limited with respect to the above center frequencies however.

FIG. 2 illustrates FEM circuitry 200 in accordance with some embodiments. The FEM circuitry 200 is one example of circuitry that may be suitable for use as the WLAN and/or BT FEM circuitry 104A/104B (FIG. 1), although other circuitry configurations may also be suitable.

In some embodiments, the FEM circuitry 200 may include a TX/RX switch 202 to switch between transmit mode and receive mode operation. The FEM circuitry 200 may include a receive signal path and a transmit signal path. The receive signal path of the FEM circuitry 200 may include a low-noise amplifier (LNA) 206 to amplify received RF signals 203 and provide the amplified received RF signals 207 as an output (e.g., to the radio IC circuitry 106 (FIG. 1)). The transmit signal path of the circuitry 200 may include a power amplifier (PA) to amplify input RF signals 209 (e.g., provided by the radio IC circuitry 106), and one or more filters 212, such as band-pass filters (BPFs), low-pass filters (LPFs) or other types of filters, to generate RF signals 215 for subsequent transmission (e.g., by one or more of the antennas 101 (FIG. 1)).

In some dual-mode embodiments for Wi-Fi communication, the FEM circuitry 200 may be configured to operate in either the 2.4 GHz frequency spectrum or the 5 GHz frequency spectrum. In these embodiments, the receive signal path of the FEM circuitry 200 may include a receive signal path duplexer 204 to separate the signals from each spectrum as well as provide a separate LNA 206 for each spectrum as shown. In these embodiments, the transmit signal path of the FEM circuitry 200 may also include a power amplifier 210 and a filter 212, such as a BPF, a LPF or another type of filter for each frequency spectrum and a transmit signal path duplexer 214 to provide the signals of one of the different spectrums onto a single transmit path for subsequent transmission by the one or more of the antennas 101 (FIG. 1). In some embodiments, BT communications may utilize the 2.4 GHZ signal paths and may utilize the same FEM circuitry 200 as the one used for WLAN communications.

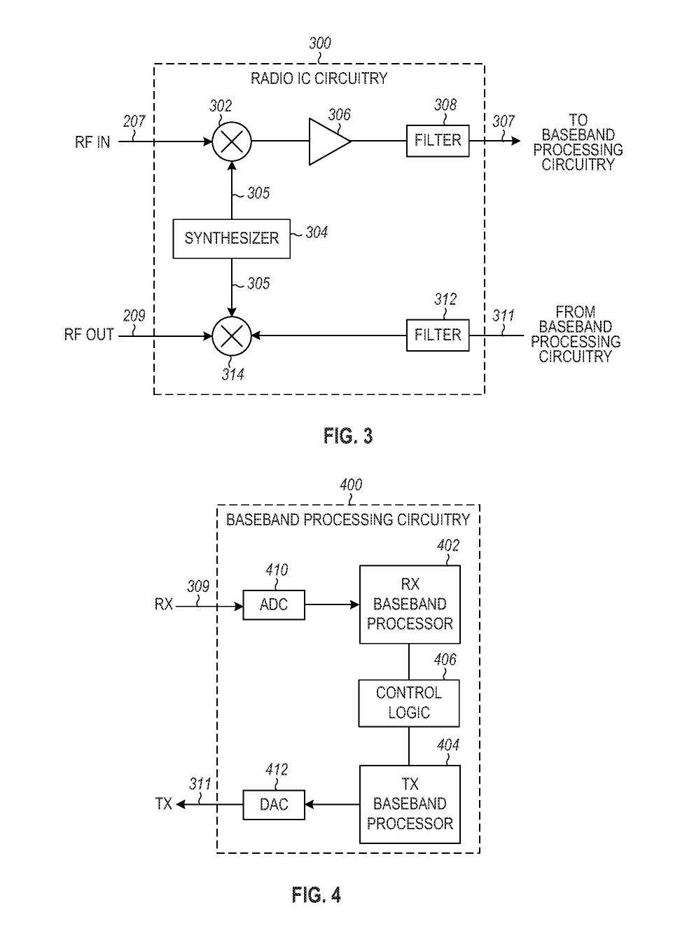

FIG. 3 illustrates radio integrated circuit (IC) circuitry 300 in accordance with some embodiments. The radio IC circuitry 300 is one example of circuitry that may be suitable for use as the WLAN or BT radio IC circuitry 106A/106B (FIG. 1), although other circuitry configurations may also be suitable.

In some embodiments, the radio IC circuitry 300 may include a receive signal path and a transmit signal path. The receive signal path of the radio IC circuitry 300 may include at least mixer circuitry 302, such as, for example, down-conversion mixer circuitry, amplifier circuitry 306 and filter circuitry 308. The transmit signal path of the radio IC circuitry 300 may include at least filter circuitry 312 and mixer circuitry 314, such as, for example, up-conversion mixer circuitry. Radio IC circuitry 300 may also include synthesizer circuitry 304 for synthesizing a frequency 305 for use by the mixer circuitry 302 and the mixer circuitry 314. The mixer circuitry 302 and/or 314 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 3 illustrates only a simplified version of a radio IC circuitry, and may include, although not shown, embodiments where each of the depicted circuitries may include more than one component. For instance, mixer circuitry 320 and/or 314 may each include one or more mixers, and filter circuitries 308 and/or 312 may each include one or more filters, such as one or more BPFs and/or LPFs according to application needs. For example, when mixer circuitries are of the direct-conversion type, they may each include two or more mixers.

In some embodiments, mixer circuitry 302 may be configured to down-convert RF signals 207 received from the FEM circuitry 104 (FIG. 1) based on the synthesized frequency 305 provided by synthesizer circuitry 304. The amplifier circuitry 306 may be configured to amplify the down-converted signals and the filter circuitry 308 may include a LPF configured to remove unwanted signals from the down-converted signals to generate output baseband signals 307. Output baseband signals 307 may be provided to the baseband processing circuitry 108 (FIG. 1) for further processing. In some embodiments, the output baseband signals 307 may be zero-frequency baseband signals, although this is not a requirement. In some embodiments, mixer circuitry 302 may comprise passive mixers, although the scope of the embodiments is not limited in this respect.

In some embodiments, the mixer circuitry 314 may be configured to up-convert input baseband signals 311 based on the synthesized frequency 305 provided by the synthesizer circuitry 304 to generate RF output signals 209 for the FEM circuitry 104. The baseband signals 311 may be provided by the baseband processing circuitry 108 and may be filtered by filter circuitry 312. The filter circuitry 312 may include a LPF or a BPF, although the scope of the embodiments is not limited in this respect.

In some embodiments, the mixer circuitry 302 and the mixer circuitry 314 may each include two or more mixers and may be arranged for quadrature down-conversion and/or up-conversion respectively with the help of synthesizer 304. In some embodiments, the mixer circuitry 302 and the mixer circuitry 314 may each include two or more mixers each configured for image rejection (e.g., Hartley image rejection). In some embodiments, the mixer circuitry 302 and the mixer circuitry 314 may be arranged for direct down-conversion and/or direct up-conversion, respectively. In some embodiments, the mixer circuitry 302 and the mixer circuitry 314 may be configured for super-heterodyne operation, although this is not a requirement.

Mixer circuitry 302 may comprise, according to one embodiment: quadrature passive mixers (e.g., for the in-phase (I) and quadrature phase (Q) paths). In such an embodiment, RF input signal 207 from FIG. 3 may be down-converted to provide I and Q baseband output signals to be sent to the baseband processor

Quadrature passive mixers may be driven by zero and ninety-degree time-varying LO switching signals provided by a quadrature circuitry which may be configured to receive a LO frequency (f_{LO}) from a local oscillator or a synthesizer, such as LO frequency 305 of synthesizer 304 (FIG. 3). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have a 25% duty cycle and a 50% offset. In some embodiments, each branch of the mixer circuitry (e.g., the in-phase (I) and quadrature phase (Q) path) may operate at a 25% duty cycle, which may result in a significant reduction is power consumption.

The RF input signal 207 (FIG. 2) may comprise a balanced signal, although the scope of the embodiments is not limited in this respect. The I and Q baseband output signals may be provided to low-nose amplifier, such as amplifier circuitry 306 (FIG. 3) or to filter circuitry 308 (FIG. 3).

In some embodiments, the output baseband signals 307 and the input baseband signals 311 may be analog baseband signals, although the scope of the embodiments is not limited in this respect. In some alternate embodiments, the output baseband signals 307 and the input baseband signals 311 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 304 may be a fractional-N synthesizer or a fractional N/N+1 synthesizer, although the scope of the embodiments is not limited in this respect as other types of frequency synthesizers may be suitable. For example, synthesizer circuitry 304 may be a delta-sigma synthesizer, a frequency multiplier, or a synthesizer comprising a phase-locked loop with a frequency divider. According to some embodiments, the synthesizer circuitry 304 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuity 304 may be provided by a voltage controlled oscillator (VCO), although that is not a requirement. A divider control input may further be provided by either the baseband processing circuitry 108 (FIG. 1) or the application processor 111 (FIG. 1) depending on the desired output frequency 305. In some embodiments, a divider control input (e.g., N) may be determined from a look-up table (e.g., within a Wi-Fi card) based on a channel number and a channel center frequency as determined or indicated by the application processor 111.

In some embodiments, synthesizer circuitry 304 may be configured to generate a carrier frequency as the output frequency 305, while in other embodiments, the output frequency 305 may be a fraction of the carrier frequency (e.g., one-half the carrier frequency, one-third the carrier frequency). In some embodiments, the output frequency 305 may be a LO frequency (f_{LO}).

FIG. 4 illustrates a functional block diagram of baseband processing circuitry 400 in accordance with some embodiments. The baseband processing circuitry 400 is one example of circuitry that may be suitable for use as the baseband processing circuitry 108 (FIG. 1), although other circuitry configurations may also be suitable. The baseband processing circuitry 400 may include a receive baseband processor (RX BBP) 402 for processing receive baseband signals 309 provided by the radio IC circuitry 106 (FIG. 1) and a transmit baseband processor (TX BBP) 404 for generating transmit baseband signals 311 for the radio IC circuitry 106. The baseband processing circuitry 400 may also include control logic 406 for coordinating the operations of the baseband processing circuitry 400.

In some embodiments (e.g., when analog baseband signals are exchanged between the baseband processing circuitry 400 and the radio IC circuitry 106), the baseband processing circuitry 400 may include ADC 410 to convert analog baseband signals received from the radio IC circuitry 106 to digital baseband signals for processing by the RX BBP 402. In these embodiments, the baseband processing circuitry 400 may also include DAC 412 to convert digital baseband signals from the TX BBP 404 to analog baseband signals.

In some embodiments that communicate OFDM signals or OFDMA signals, such as through baseband processor 108A, the transmit baseband processor 404 may be configured to generate OFDM or OFDMA signals as appropriate for transmission by performing an inverse fast Fourier transform (IFFT). The receive baseband processor 402 may be configured to process received OFDM signals or OFDMA signals by performing an FFT. In some embodiments, the receive baseband processor 402 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring to FIG. 1, in some embodiments, the antennas 101 (FIG. 1) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 101 may each include a set of phased-array antennas, although embodiments are not so limited.

Although the wireless system 100 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

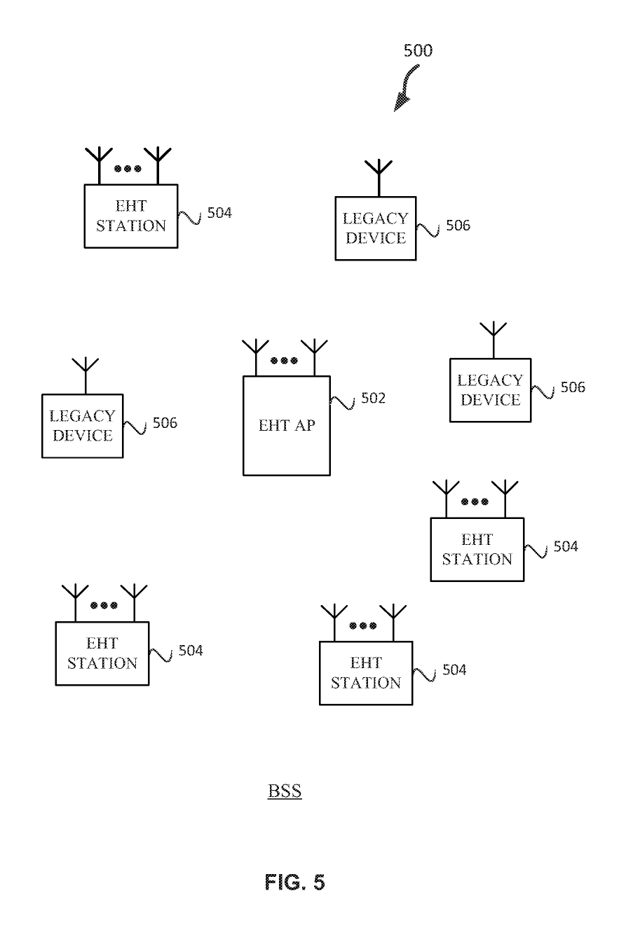

FIG. 5 illustrates a WLAN 500 in accordance with some embodiments. The WLAN 500 may comprise a basis service set (BSS) that may include a EHT access point (AP) 502, a plurality of EHT (e.g., IEEE 802.11EHT) stations (STAs) 504 such as non-AP STAs, and a plurality of legacy (e.g., IEEE 802.11n/ac/ax) devices 506. In some embodiments, the EHT STAs 504 are configured to operate in accordance with IEEE 802.11ax. In some embodiments, IEEE 802.11EHT may be termed Next Generation 802.11. In some embodiments, the EHT APs 502 are configured to operate in accordance with IEEE 802.11ax.

The EHT AP 502 may be an AP using the IEEE 802.11 to transmit and receive. The EHT AP 502 may be a base station. The EHT AP 502 may use other communications protocols as well as the IEEE 802.11 protocol. The IEEE 802.11 protocol may be IEEE 802.11ax. The IEEE 802.11 protocol may be IEEE 802.11 next generation. The EHT protocol may be termed a different name in accordance with some embodiments. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIMO). There may be more than one EHT AP 502 that is part of an extended service set (ESS). A controller (not illustrated) may store information that is common to the more than one EHT APs 502 and may control more than one BSS, e.g., assign primary channels, colors, etc. EHT AP 502 may be connected to the internet.

The legacy devices 506 may operate in accordance with one or more of IEEE 802.11 a/b/g/n/ac/ad/af/ah/aj/ay/ax, or another legacy wireless communication standard. The legacy devices 506 may be STAs or IEEE STAs. The EHT STAs 504 may be wireless transmit and receive devices such as cellular telephone, portable electronic wireless communication devices, smart telephone, handheld wireless device, wireless glasses, wireless watch, wireless personal device, tablet, or another device that may be transmitting and receiving using the IEEE 802.11 protocol such as IEEE 802.11EHT or another wireless protocol. In some embodiments, the EHT STAs 504 may be termed extremely high throughput (EHT) stations or stations.

The EHT AP 502 may communicate with legacy devices 506 in accordance with legacy IEEE 802.11 communication techniques. In example embodiments, the EHT AP 502 may also be configured to communicate with EHT STAs 504 in accordance with legacy IEEE 802.11 communication techniques.

In some embodiments, a EHT frame may be configurable to have the same bandwidth as a channel. The EHT frame may be a physical Layer Convergence Procedure (PLCP) Protocol Data Unit (PPDU). In some embodiments, there may be different types of PPDUs that may have different fields and different physical layers and/or different media access control (MAC) layers. For example, a single user (SU) PPDU, multiple-user (MU) PPDU, extended-range (ER) SU PPDU, and/or trigger-based (TB) PPDU. In some embodiments EHT may be the same or similar as HE PPDUs.

The bandwidth of a channel may be 20 MHz, 40 MHz, or 80 MHz, 80+80 MHz, 160 MHz, 160+160 MHz, 320 MHz, 320+320 MHz, 480 MHz (such as 160+160+160 MHz), 640 MHz bandwidths. In some embodiments, the bandwidth of a channel less than 20 MHz may be 1 MHz, 1.25 MHz, 2.03 MHz, 2.5 MHz, 4.06 MHz, 5 MHz and 10 MHz, or a combination thereof or another bandwidth that is less or equal to the available bandwidth may also be used. In some embodiments the bandwidth of the channels may be based on a number of active data subcarriers. In some embodiments the bandwidth of the channels is based on 26, 52, 106, 242, 484, 996, or 2×996 active data subcarriers or tones that occupy a bandwidth of 20 MHz. In some embodiments the bandwidth of the channels is 256 tones spaced by 20 MHz. In some embodiments the channels are multiple of 26 tones or a multiple of 20 MHz. In some embodiments a 20 MHz channel may comprise 242 active data subcarriers or tones, which may determine the size of a Fast Fourier Transform (FFT). An allocation of a bandwidth or a number of tones or sub-carriers may be termed a resource unit (RU) allocation in accordance with some embodiments.

In some embodiments, the 26-subcarrier RU and 52-subcarrier RU are used in the 20 MHz, 40 MHz, 80 MHz, 160 MHz and 80+80 MHz OFDMA HE PPDU formats. In some embodiments, the 106-subcarrier RU is used in the 20 MHz, 40 MHz, 80 MHz, 160 MHz and 80+80 MHz OFDMA and MU-MIMO HE PPDU formats. In some embodiments, the 242-subcarrier RU is used in the 40 MHz, 80 MHz, 160 MHz and 80+80 MHz OFDMA and MU-MIMO HE PPDU formats. In some embodiments, the 484-subcarrier RU is used in the 80 MHz, 160 MHz and 80+80 MHz OFDMA and MU-MIMO HE PPDU formats. In some embodiments, the 996-subcarrier RU is used in the 160 MHz and 80+80 MHz OFDMA and MU-MIMO HE PPDU formats.

A EHT frame may be configured for transmitting a number of spatial streams, which may be in accordance with MU-MIMO and may be in accordance with OFDMA. In other embodiments, the EHT AP 502, EHT STA 504, and/or legacy device 506 may also implement different technologies such as code division multiple access (CDMA) 2000, CDMA 2000 1×, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), BlueTooth®, low-power BlueTooth®, or other technologies.

Some embodiments relate to EHT communications. In accordance with some IEEE 802.11 embodiments, e.g., IEEE 802.11EHT/ax embodiments, a EHT AP 502 may operate as a master station which may be arranged to contend for a wireless medium (e.g., during a contention period) to receive exclusive control of the medium for a transmission opportunity (TXOP). The EHT AP 502 may transmit a EHT/HE trigger frame transmission, which may include a schedule for simultaneous UL transmissions from EHT STAs 504. The EHT AP 502 may transmit a time duration of the TXOP and sub-channel information. During the TXOP, EHT STAs 504 may communicate with the EHT AP 502 in accordance with a non-contention based multiple access technique such as OFDMA or MU-MIMO. This is unlike conventional WLAN communications in which devices communicate in accordance with a contention-based communication technique, rather than a multiple access technique. During the EHT control period, the EHT AP 502 may communicate with EHT stations 504 using one or more EHT frames. During the TXOP, the EHT STAs 504 may operate on a sub-channel smaller than the operating range of the EHT AP 502. During the TXOP, legacy stations refrain from communicating. The legacy stations may need to receive the communication from the EHT AP 502 to defer from communicating.

In accordance with some embodiments, during the TXOP the EHT STAs 504 may contend for the wireless medium with the legacy devices 506 being excluded from contending for the wireless medium during the master-sync transmission. In some embodiments the trigger frame may indicate an UL-MU-MIMO and/or UL OFDMA TXOP. In some embodiments, the trigger frame may include a DL UL-MU-MIMO and/or DL OFDMA with a schedule indicated in a preamble portion of trigger frame.

In some embodiments, the multiple-access technique used during the EHT TXOP may be a scheduled OFDMA technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique. In some embodiments, the multiple access technique may be a Code division multiple access (CDMA).

The EHT AP 502 may also communicate with legacy stations 506 and/or EHT stations 504 in accordance with legacy IEEE 802.11 communication techniques. In some embodiments, the EHT AP 502 may also be configurable to communicate with EHT stations 504 outside the HE TXOP in accordance with legacy IEEE 802.11 or IEEE 802.11EHT communication techniques, although this is not a requirement.

In some embodiments the EHT station 504 may be a “group owner” (GO) for peer-to-peer modes of operation. A wireless device may be a EHT station 502 or a EHT AP 502.

In some embodiments, the EHT STA 504 and/or EHT AP 502 may be configured to operate in accordance with IEEE 802.11mc. In example embodiments, the radio architecture of FIG. 1 is configured to implement the EHT STA 504 and/or the EHT AP 502. In example embodiments, the front-end module circuitry of FIG. 2 is configured to implement the EHT STA 504 and/or the EHT AP 502. In example embodiments, the radio IC circuitry of FIG. 3 is configured to implement the EHT station 504 and/or the EHT AP 502. In example embodiments, the base-band processing circuitry of FIG. 4 is configured to implement the EHT station 504 and/or the EHT AP 502.

In example embodiments, the EHT stations 504 or EHT AP 502, a wireless communication device of the EHT stations 504, and/or a wireless communication device of the EHT AP 502 may include one or more of the following: the wireless system of FIG. 1 and/or any of the components therein, the front-end module circuitry of FIG. 2, the radio IC circuitry of FIG. 3, and/or the base-band processing circuitry of FIG. 4.

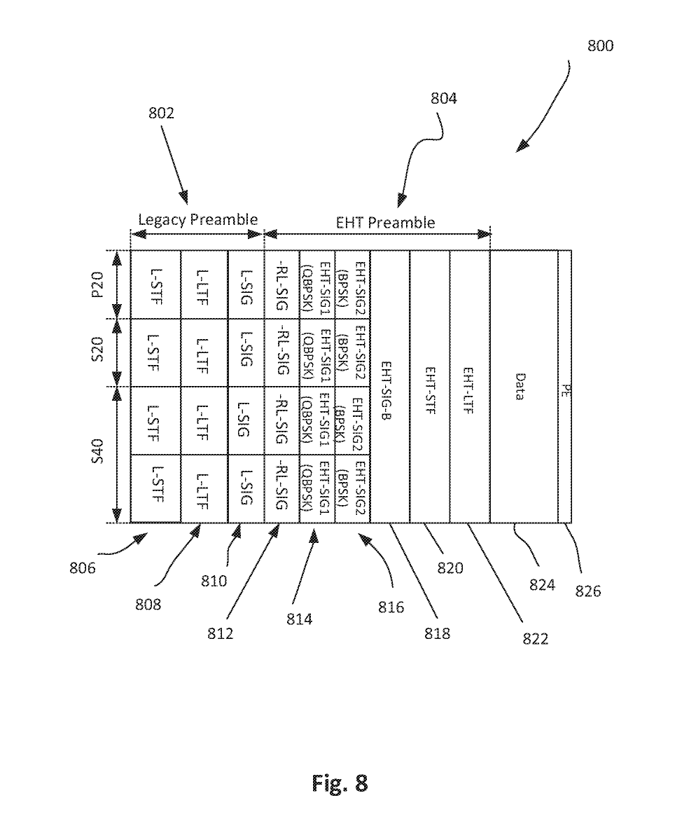

In example embodiments, the wireless system of FIG. 1 or any components thereof, the front-end module circuitry of FIG. 2, the radio IC circuitry of FIG. 3, and/or the base-band processing circuitry of FIG. 4 may be configured to perform the methods and operations/functions herein described in conjunction with FIGS. 8-16.

In example embodiments, the EHT station 504 and/or the EHT AP 502 are configured to perform the methods and operations/functions described herein in conjunction with FIGS. 8-16. In example embodiments, an apparatus of the EHT station 504 and/or an apparatus of the EHT AP 502 are configured to perform the methods and functions described herein in conjunction with FIGS. 8-16. The term Wi-Fi may refer to one or more of the IEEE 802.11 communication standards. AP and STA may refer to EHT access point 502 and/or EHT station 504 as well as legacy devices 506.

In some embodiments, a EHT AP STA may refer to a EHT AP 502 and/or a EHT STAB 504 that is operating as a EHT APs 502. In some embodiments, when a EHT STA 504 is not operating as a EHT AP, it may be referred to as a EHT non-AP STA or EHT non-AP. In some embodiments, EHT STA 504 may be referred to as either a EHT AP STA or a EHT non-AP.

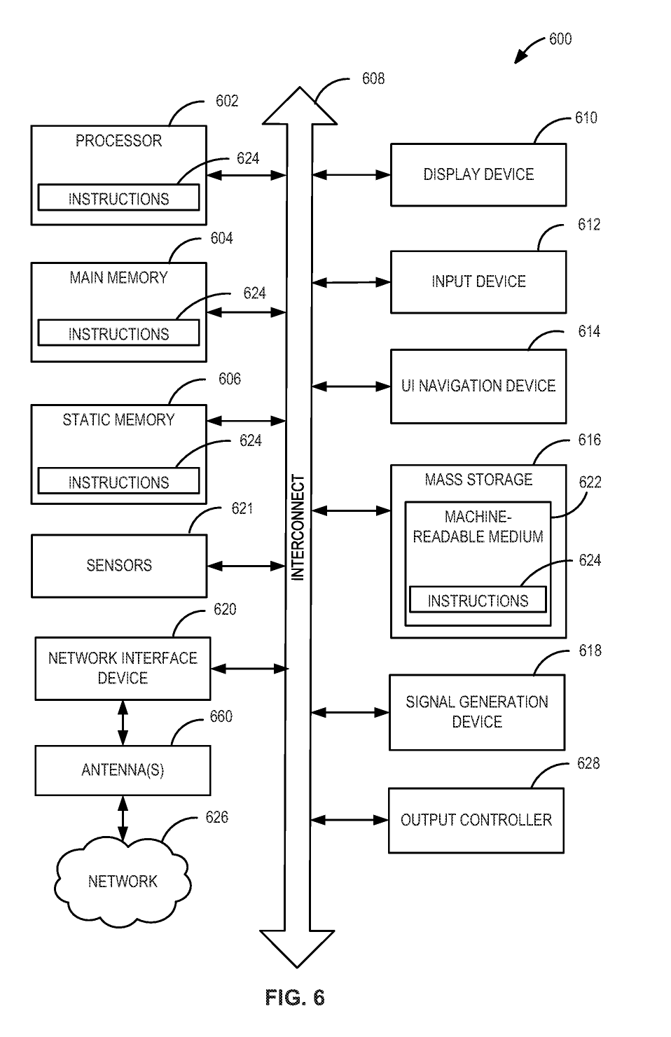

FIG. 6 illustrates a block diagram of an example machine 600 upon which any one or more of the techniques (e.g., methodologies) discussed herein may perform. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a EHT AP 502, EHT station 504, personal computer (PC), a tablet PC, a set-top box (STB), a personal digital assistant (PDA), a portable communications device, a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608.

Specific examples of main memory 604 include Random Access Memory (RAM), and semiconductor memory devices, which may include, in some embodiments, storage locations in semiconductors such as registers. Specific examples of static memory 606 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks.

The machine 600 may further include a display device 610, an input device 612 (e.g., a keyboard), and a user interface (UI) navigation device 614 (e.g., a mouse). In an example, the display device 610, input device 612 and UI navigation device 614 may be a touch screen display. The machine 600 may additionally include a mass storage (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared(IR), near field communication (NFC), etc.) connection to communicate or control one or more peripheral devices (e.g., a printer, card reader, etc.). In some embodiments the processor 602 and/or instructions 624 may comprise processing circuitry and/or transceiver circuitry.

The storage device 616 may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the storage device 616 may constitute machine readable media.

Specific examples of machine readable media may include: non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks.

While the machine readable medium 622 is illustrated as a single medium, the term “machine readable medium” may include a single medium or multiple media (e.g., a centralized or distributed database, and/or associated caches and servers) configured to store the one or more instructions 624.

An apparatus of the machine 600 may be one or more of a hardware processor 602 (e.g., a central processing unit (CPU), a graphics processing unit (GPU), a hardware processor core, or any combination thereof), a main memory 604 and a static memory 606, sensors 621, network interface device 620, antennas 660, a display device 610, an input device 612, a UI navigation device 614, a mass storage 616, instructions 624, a signal generation device 618, and an output controller 628. The apparatus may be configured to perform one or more of the methods and/or operations disclosed herein. The apparatus may be intended as a component of the machine 600 to perform one or more of the methods and/or operations disclosed herein, and/or to perform a portion of one or more of the methods and/or operations disclosed herein. In some embodiments, the apparatus may include a pin or other means to receive power. In some embodiments, the apparatus may include power conditioning hardware.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine-readable media. In some examples, machine readable media may include machine readable media that is not a transitory propagating signal.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others.

In an example, the network interface device 620 may include one or more physical jacks (e.g., Ethernet, coaxial, or phone jacks) or one or more antennas to connect to the communications network 626. In an example, the network interface device 620 may include one or more antennas 660 to wirelessly communicate using at least one of single-input multiple-output (SIMO), multiple-input multiple-output (MIMO), or multiple-input single-output (MISO) techniques. In some examples, the network interface device 620 may wirelessly communicate using Multiple User MIMO techniques. The term “transmission medium” shall be taken to include any intangible medium that is capable of storing, encoding or carrying instructions for execution by the machine 600, and includes digital or analog communications signals or other intangible medium to facilitate communication of such software.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Some embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; flash memory, etc.

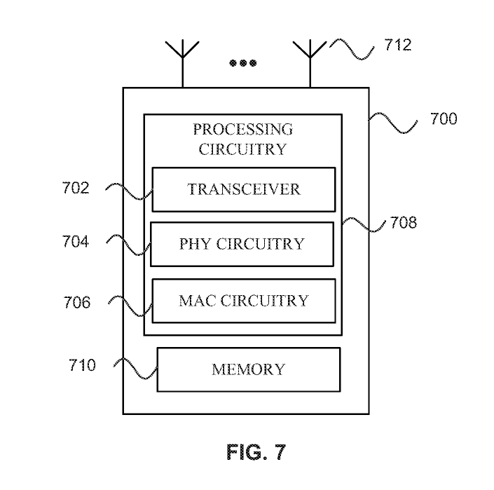

FIG. 7 illustrates a block diagram of an example wireless device 700 upon which any one or more of the techniques (e.g., methodologies or operations) discussed herein may perform. The wireless device 700 may be a HE device or EHT wireless device. The wireless device 700 may be a EHT STA 504, EHT AP 502, and/or a HE STA or HEAP. A EHT STA 504, EHT AP 502, and/or a HE AP or HE STA may include some or all of the components shown in FIGS. 1-7. The wireless device 700 may be an example machine 600 as disclosed in conjunction with FIG. 6.

The wireless device 700 may include processing circuitry 708. The processing circuitry 708 may include a transceiver 702, physical layer circuitry (PHY circuitry) 704, and MAC layer circuitry (MAC circuitry) 706, one or more of which may enable transmission and reception of signals to and from other wireless devices 700 (e.g., EHT AP 502, EHT STA 504, and/or legacy devices 506) using one or more antennas 712. As an example, the PHY circuitry 704 may perform various encoding and decoding functions that may include formation of baseband signals for transmission and decoding of received signals. As another example, the transceiver 702 may perform various transmission and reception functions such as conversion of signals between a baseband range and a Radio Frequency (RF) range.

Accordingly, the PHY circuitry 704 and the transceiver 702 may be separate components or may be part of a combined component, e.g., processing circuitry 708. In addition, some of the described functionality related to transmission and reception of signals may be performed by a combination that may include one, any or all of the PHY circuitry 704 the transceiver 702, MAC circuitry 706, memory 710, and other components or layers. The MAC circuitry 706 may control access to the wireless medium. The wireless device 700 may also include memory 710 arranged to perform the operations described herein, e.g., some of the operations described herein may be performed by instructions stored in the memory 710.

The antennas 712 (some embodiments may include only one antenna) may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas 712 may be effectively separated to take advantage of spatial diversity and the different channel characteristics that may result.

One or more of the memory 710, the transceiver 702, the PHY circuitry 704, the MAC circuitry 706, the antennas 712, and/or the processing circuitry 708 may be coupled with one another. Moreover, although memory 710, the transceiver 702, the PHY circuitry 704, the MAC circuitry 706, the antennas 712 are illustrated as separate components, one or more of memory 710, the transceiver 702, the PHY circuitry 704, the MAC circuitry 706, the antennas 712 may be integrated in an electronic package or chip.

In some embodiments, the wireless device 700 may be a mobile device as described in conjunction with FIG. 6. In some embodiments the wireless device 700 may be configured to operate in accordance with one or more wireless communication standards as described herein (e.g., as described in conjunction with FIGS. 1-6, IEEE 802.11). In some embodiments, the wireless device 700 may include one or more of the components as described in conjunction with FIG. 6 (e.g., display device 610, input device 612, etc.) Although the wireless device 700 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

In some embodiments, an apparatus of or used by the wireless device 700 may include various components of the wireless device 700 as shown in FIG. 7 and/or components from FIGS. 1-6. Accordingly, techniques and operations described herein that refer to the wireless device 700 may be applicable to an apparatus for a wireless device 700 (e.g., EHT AP 502 and/or EHT STA 504), in some embodiments. In some embodiments, the wireless device 700 is configured to decode and/or encode signals, packets, and/or frames as described herein, e.g., PPDUs.

In some embodiments, the MAC circuitry 706 may be arranged to contend for a wireless medium during a contention period to receive control of the medium for a EHT TXOP and encode or decode an EHT PPDU. In some embodiments, the MAC circuitry 706 may be arranged to contend for the wireless medium based on channel contention settings, a transmitting power level, and a clear channel assessment level (e.g., an energy detect level).

The PHY circuitry 704 may be arranged to transmit signals in accordance with one or more communication standards described herein. For example, the PHY circuitry 704 may be configured to transmit a EHT PPDU. The PHY circuitry 704 may include circuitry for modulation/demodulation, upconversion/downconversion, filtering, amplification, etc. In some embodiments, the processing circuitry 708 may include one or more processors. The processing circuitry 708 may be configured to perform functions based on instructions being stored in a RAM or ROM, or based on special purpose circuitry. The processing circuitry 708 may include a processor such as a general purpose processor or special purpose processor. The processing circuitry 708 may implement one or more functions associated with antennas 712, the transceiver 702, the PHY circuitry 704, the MAC circuitry 706, and/or the memory 710. In some embodiments, the processing circuitry 708 may be configured to perform one or more of the functions/operations and/or methods described herein.

In mmWave technology using a mmWave baseband processing circuitry (now shown), communication between a station (e.g., the EHT stations 504 of FIG. 5 or wireless device 700) and an access point (e.g., the EHT AP 502 of FIG. 5 or wireless device 700) may use associated effective wireless channels that are highly directionally dependent. To accommodate the directionality, beamforming techniques may be utilized to radiate energy in a certain direction with certain beamwidth to communicate between two devices. The directed propagation concentrates transmitted energy toward a target device in order to compensate for significant energy loss in the channel between the two communicating devices. Using directed transmission may extend the range of the millimeter-wave communication versus utilizing the same transmitted energy in omni-directional propagation.

Some embodiments pertain to a wireless device, such as a baseband processing circuitry 108A of FIG. 1, of a first Extremely High Throughput (EHT) wireless station (STA), such as wireless system 100 of FIG. 1, or EHT AP 502, the device comprising physical layer (PHY layer) circuitry and Medium Access Control layer (MAC) layer circuitry connected to the PHY layer circuitry, the PHY layer circuitry including logic to: encode a physical Layer Convergence Procedure (PLCP) Protocol Data Unit (PPDU), the PPDU being an EHT PPDU including a legacy preamble portion, an EHT preamble portion, and a data portion following the EHT preamble portion, the EHT preamble portion including: a first signal (SIG) field configured such that a second EHT station (STA) processing the first SIG field is to identify the PPDU as an EHT PPDU based on the first SIG field; and a second SIG field following the first SIG field, the second SIG field corresponding to an EHT signal (SIG) field; and cause transmission of the EHT PPDU to the second EHT STA.

Some embodiments pertain to a wireless device, such as a baseband processing circuitry 108A of FIG. 1, of a first Extremely High Throughput (EHT) wireless station (STA), such as wireless system 100 of FIG. 1, or EHT STA 504, the device comprising physical layer (PHY layer) circuitry and Medium Access Control layer (MAC) layer circuitry connected to the PHY layer circuitry, the PHY layer circuitry including logic to: encode a physical Layer Convergence Procedure (PLCP) Protocol Data Unit (PPDU), the PPDU being an EHT PPDU including a legacy preamble portion, an EHT preamble portion, and a data portion following the EHT preamble portion, the EHT preamble portion including: a first signal (SIG) field configured such that a second EHT station (STA) processing the first SIG field is to identify the PPDU as an EHT PPDU based on the first SIG field; and a second SIG field following the first SIG field, the second SIG field corresponding to an EHT signal (SIG) field; and cause transmission of the EHT PPDU to the second EHT STA.

Some embodiments pertain to a wireless device, such as a baseband processing circuitry 108A of FIG. 1, of a first Extremely High Throughput (EHT) wireless station (STA), such as wireless system 100 of FIG. 1, or EHT STA 504, the device comprising physical layer (PHY layer) circuitry and Medium Access Control layer (MAC) layer circuitry connected to the PHY layer circuitry, the PHY layer circuitry including logic to: decode a legacy signal field (L-SIG field) of a physical Layer Convergence Procedure (PLCP) Protocol Data Unit (PPDU), the PPDU being an EHT PPDU including a legacy preamble portion that comprises the L-SIG field, an EHT preamble portion following the legacy preamble portion, and a data portion following the EHT preamble portion, the EHT preamble portion including a signal (SIG) field; identify, based on the SIG field of the EHT preamble portion, that the PPDU is an EHT PPDU; decode the EHT preamble portion based on identifying the PPDU as an EHT PPDU; and decode the data portion based on the EHT preamble portion.

Embodiments allow the legacy preamble to exist in every 20 MHz bandwidth for backward compatibility with HE STA's.

Embodiments provide a new Wi-Fi preamble to support EHT. The preamble structure design provides the following advantages: (1) it affords the ability of STA's to be able to differentiate EHT PPDU's with high reliability; (2) it is configured to enable legacy (non-EHT) STAs to perform early termination (ET) of PPDU detection and decoding if a EHT PPDU is received by the legacy STA; (3) it is backward compatible with legacy STAs. Some embodiments further provide mechanisms that can be used to signal or differentiate various EHT PPDU types.

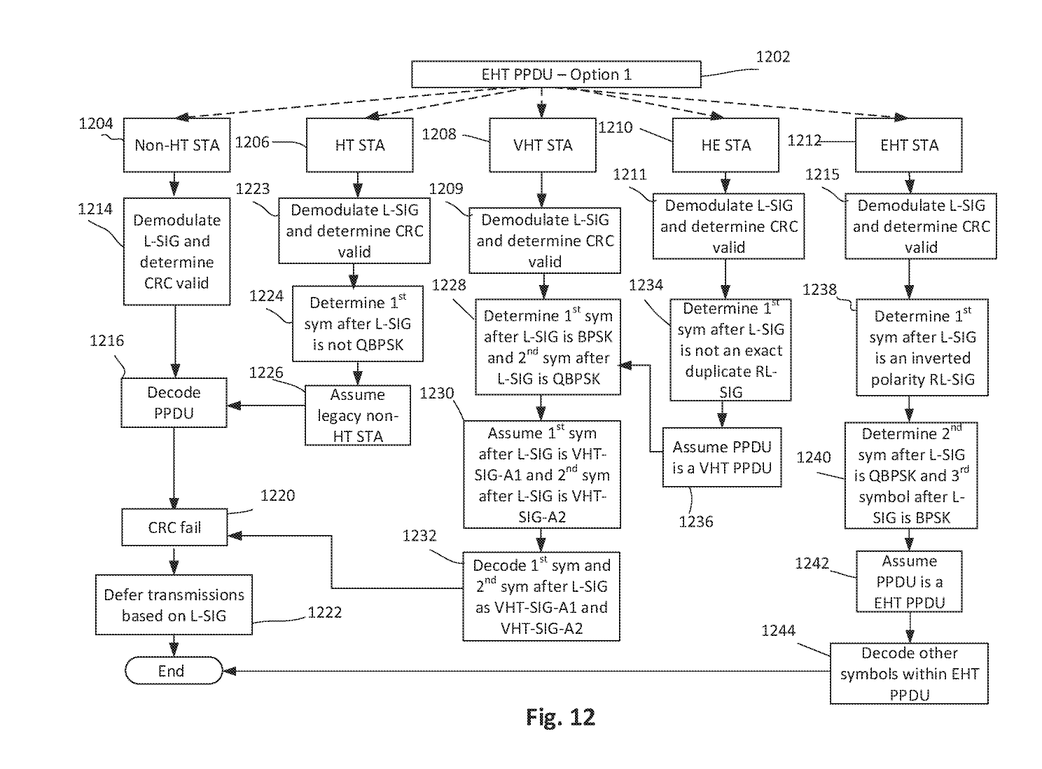

FIGS. 8 and 9, 10, and 11 respectively pertain to three different embodiments of a EHT PPDU configuration. FIGS. 12, 13 and 14 depict respective flowcharts showing a processing of the EHT PPDU according to each of the respective three embodiments by legacy STAs and by EHT STAs. While the PPDUs shown and/or referred to in these figures occur on 80 MHz, embodiments are not so limited. Details regarding the three embodiments are provided below in relation to FIGS. 8-16.

Referring first to FIG. 8, a first embodiment of a EHT PPDU configuration 800 is shown. PPDU 800 takes place on a primary 20 MHz channel P20, a secondary 20 MHz channel S20 and a secondary 40 MHz channel S40 as shown. EHT PPDU 800 includes a legacy preamble portion 802, and an EHT preamble portion 804, EHT preamble portion 804 being in accordance with the first embodiment. In the shown embodiment, EHT PPDU 800 further includes an EHT SIG field that, in the shown embodiment, includes an EHT-SIG 1 field 814 and an EHT-SIG 2 field 816. The legacy preamble portion 802 includes a legacy short training field (L-STF field) 806, a legacy long training field (L-LTF field) 808, and a legacy signal field (L-SIG field) 810. In the shown embodiment, the legacy preamble portion 802 is followed by a repeated L-SIG field (RL-SIG field) 812 that a has a polarity that is reversed with respect to the polarity of the L-SIG field. In other words, the -RL-SIG field 814 corresponds to a duplicate of the L-SIG field 810 except that the polarity of the -RL-SIG field 814 is reversed with respect to a polarity of the L-SIG field 810, hence the “-” in front of the “-RL-SIG” field name. -RL-SIG is therefore still BPSK modulated, similar to the L-SIG field. In the shown embodiment, the EHT SIG 1 814 is modulated using quadrature binary phase shift keying (QBPSK), and the EHT SIG 2 816 is modulated suing binary phase shift keying (BPSK), although embodiments are not so limited. Thus, the first embodiment includes within its scope the possibility to have EHT SIG 1 and EHT SIG 2 have the same modulation, such as BPSK or QBPSK. The EHT preamble 804 in the shown embodiment also includes a EHT SIG B field 818 in the case where the EHT PPDU 800 is a Multi-User Multiple-Input Multiple-Output (MU-MIMO) PPDU. Embodiments however are not limited to EHT PPDU 800 including the EHT SIG B field 818. The EHT preamble 804 further includes an EHT-STF 820 and an EHT-LTF 822, and is shown as being followed by a data portion 824 and a packet extension PE 826. In the current HE standard, the use of an RL-SIG was introduced, but as an exact copy or duplicate of the L-SIG, and not inverted as proposed herein.

The PPDU format according to the first embodiment as shown in FIG. 8 advantageously allows an EHT STA to differentiate an EHT PPDU from non-high-throughput (non-HT), a high-throughput (HT), a very high throughput (VHT), and a high-efficiency (HE) PPDU with high reliability. The -RL-SIG, that is, the inverted polarity RL-SIG, may be used as a delineator that the PPDU is an EHT PPDU. In order to enable a more reliable identification of the PPDU as an EHT PPDU, the first embodiment as shown in FIG. 8 proposes using an EHT-SIG 1 field 814 which is QBPSK modulated, along with a EHT-SIG 2 field 816 which is BPSK modulated. The inverted polarity -RL-SIG together with the QBSPK modulated EHT-SIG1 and BPSK modulated EHT-SIG2 allow for the identification of the PPDU as an EHT PPDU with very high reliability.

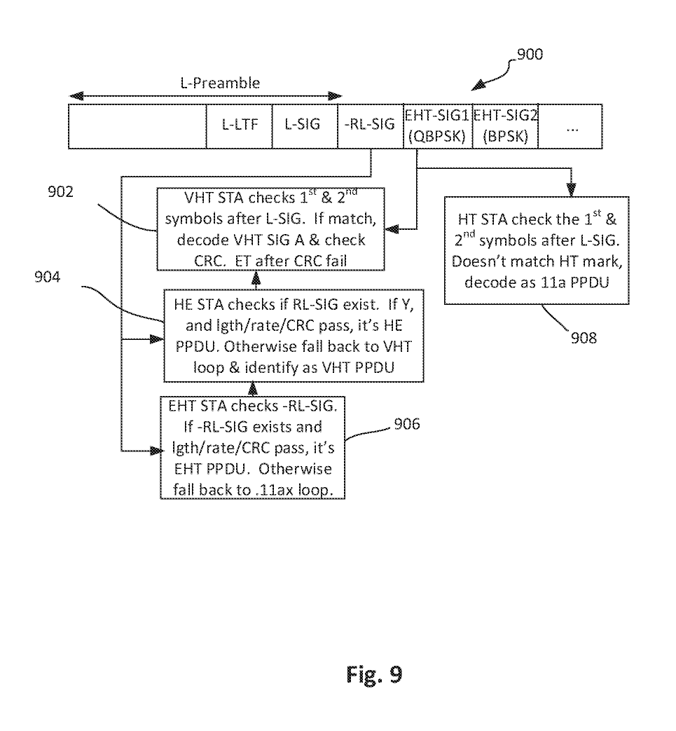

Referring now to FIG. 9, a simplified flow chart is shown in connection with an EHT PPDU 900 in accordance with the first embodiment. In FIG. 9, it is assumed that each of the VHT STA, HE STA, EHT STA and HT STA first decode the L-SIG field and ensure that CRC has passed. As shown in FIG. 9, at 902, a VHT STA would decode the first and second symbols after the L-SIG field. The CRC would pass if the symbols correspond to VHT-SIG A1 and VHT-SIG A2, which they would not in the case of a EHT PPDU according to the first embodiment. Since the CRC will not pass, the VHT would refrain from decoding the rest of the EHT PPDU (corresponding to early termination or ET). As shown at 904, a HE STA would check to determine if a RL-SIG exists, that is, an exact duplicate of the L-SIG field. If the PPDU were an HE PPDU, the first symbol after the L-SIG field would be an RL-SIG field, the length, rate and CRC would pass, and the PPDU would be treated as a HE PPDU. However, for the EHT PPDU according to the first embodiment, the HE STA would assume it has a VHT PPDU and would fall back on the VHT process as described above. As shown at 906, an EHT STA would check for a -RL-SIG according to the first embodiment. If the -RL-SIG exists and the length, rate and CRC pass, the EHT STA would demodulate the EHT-SIG and check for a valid CRC for confirmation. If the CRC passes, the EHT STA would identify the PPDU as a EHT PPDU. The CRC might still not pass due to signal-to-noise ratio (SNR) issues with the EHT-SIG field. A more detailed description of a flowchart with respect to the first embodiment EHT PPDU and how it is treated by legacy STAs and an EHT STA is provided further below in relation to FIG. 12.

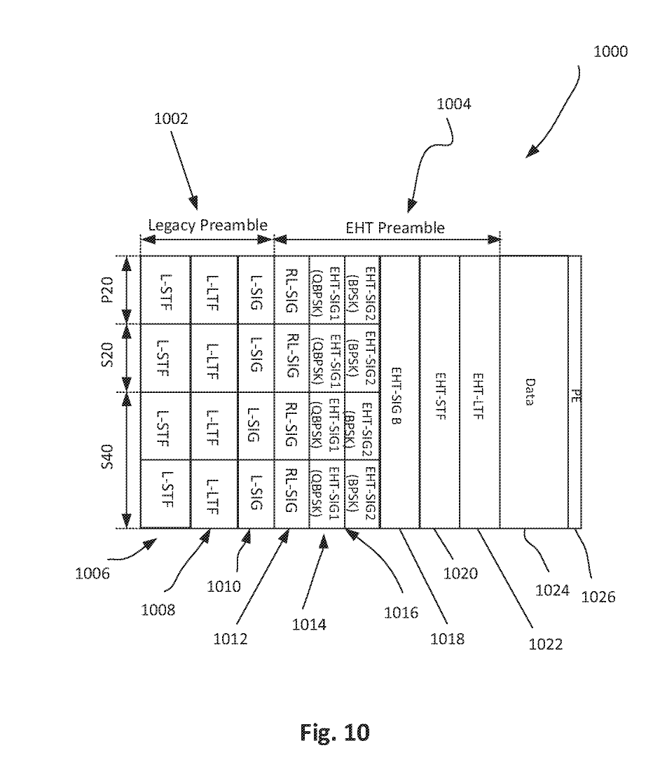

Referring next to FIG. 10, a second embodiment of a EHT PPDU configuration 1000 is shown. An only different between this second embodiment and the first embodiment of FIG. 8 is that the EHT PPDU 1000 in the second embodiment does not include a reversed polarity overlay on the RL-SIG field. In FIG. 10, EHT PPDU 1000 takes place on a primary 20 MHz channel P20, a secondary 20 MHz channel S20 and a secondary 40 MHz channel S40 as shown. EHT PPDU 1000 includes a legacy preamble portion 1002, and an EHT preamble portion 1004, EHT preamble portion 1004 being in accordance with the second embodiment. In the shown embodiment, EHT PPDU 1000 further includes an EHT SIG field that, in the shown embodiment, includes an EHT-SIG 1 field 1014 and an EHT-SIG 2 field 1016. The legacy preamble portion 1002 includes a legacy short training field (L-STF field) 1006, a legacy long training field (L-LTF field) 1008, and a legacy signal field (L-SIG field) 1010. In the shown embodiment, the legacy preamble portion 1002 is followed by a repeated L-SIG field (RL-SIG field) 1012 that is an exact duplicate of the L-SIG field, similar to the RL-SIG in 802.11ax. RL-SIG is BPSK modulated, similar to the L-SIG field. In the shown embodiment, the EHT SIG 1 1014 is modulated using quadrature binary phase shift keying (QBPSK), and the EHT SIG 2 1016 is modulated suing binary phase shift keying (BPSK). The EHT preamble 1004 in the shown embodiment also includes an EHT SIG B field 1018 in the case where the EHT PPDU 1000 is a Multi-User Multiple-Input Multiple-Output (MU-MIMO) PPDU. Embodiments however are not limited to EHT PPDU 1000 including the EHT SIG B field 1018 or to an EHT PPDU that is a MU-MIMO EHT PPDU. The EHT preamble 1004 further includes an EHT-STF 1020 and an EHT-LTF 1022, and is shown as being followed by a data portion 1024 and a packet extension PE 1026.

The PPDU format according to the second embodiment as shown in FIG. 10 advantageously allows an EHT STA to differentiate an EHT PPDU from non-HT/HT/VHT/HE PPDU with high reliability. The second embodiment as shown in FIG. 10 proposes using an EHT-SIG 1 field 1014 which is QBPSK modulated, along with a EHT-SIG 2 field 1016 which is BPSK modulated. An EHT STA determination the constellation of EHT-SIG 1 and EHT-SIG 2 would be able to identify the PPDU as an EHT PPDU in this manner.

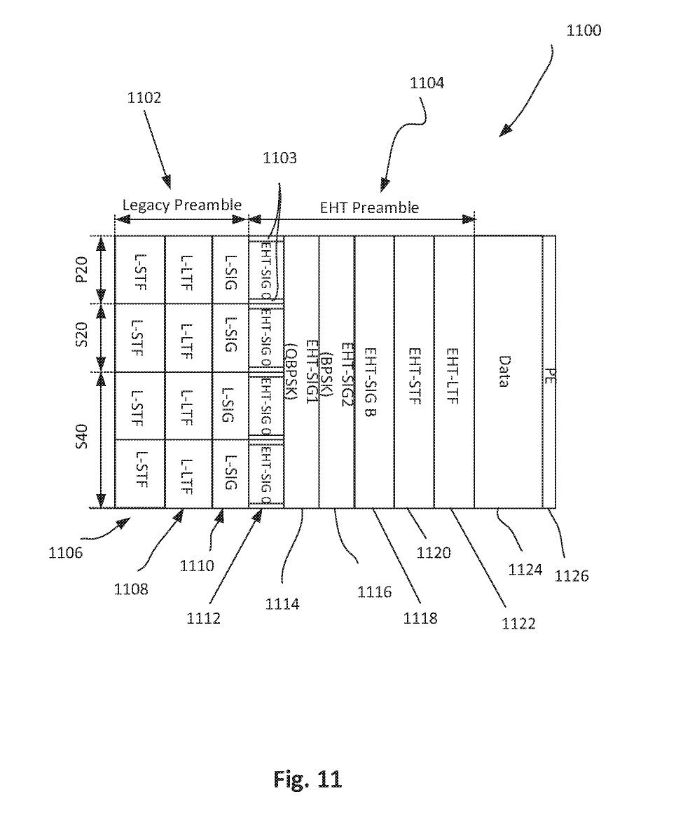

Referring next to FIG. 11, a third embodiment of a EHT PPDU configuration 1100 is shown. PPDU 1100 takes place on a primary 20 MHz channel P20, a secondary 20 MHz channel S20 and a secondary 40 MHz channel S40 as shown. EHT PPDU 1100 includes a legacy preamble portion 1102, and an EHT preamble portion 1104, EHT preamble portion 1104 being in accordance with the third embodiment. In the shown embodiment, EHT PPDU 1100 further includes an EHT SIG field that includes an EHT-SIG 1 field 1114 and an EHT-SIG 2 field 1116. The legacy preamble portion 1102 includes a legacy short training field (L-STF field) 1106, a legacy long training field (L-LTF field) 1108, and a legacy signal field (L-SIG field) 1110. In the shown embodiment, the legacy preamble portion 1102 is followed by a EHG-SIG 0 field 1112. The EHT-SIG 0 field 1112 may be BPSK modulated, similar to the L-SIG field 1110. In the shown embodiment, the EHT SIG 1 814 is modulated using quadrature binary phase shift keying (QBPSK), and the EHT SIG 2 816 is modulated suing binary phase shift keying (BPSK), although embodiments are not so limited. Thus, the third embodiment includes within its scope the possibility to have EHT SIG 1 and EHT SIG 2 have the same modulation, such as BPSK or QBPSK. The EHT preamble 1104 in the shown embodiment also includes an EHT SIG B field 1118 in the case where the EHT PPDU 1100 is a Multi-User Multiple-Input Multiple-Output (MU-MIMO) PPDU. Embodiments however are not limited to EHT PPDU 1100 including the EHT SIG B field 1118 or to an EHT PPDU that is a MU-MIMO EHT PPDU. The EHT preamble 1104 further includes an EHT-STF 1120 and an EHT-LTF 1122, and is shown as being followed by a data portion 1124 and a packet extension PE 1126.

The PPDU format according to the third embodiment as shown in FIG. 11 advantageously allows an EHT STA to differentiate an EHT PPDU from a non-high-throughput (non-HT), a high-throughput (HT), a very high throughput (VHT), and a high-efficiency (HE) PPDU quickly and with high reliability. The third embodiment as shown in FIG. 11 proposes using a dedicated EHT-SIG 0 field that may be encoded to either explicitly (through the use of encoded bits) and/or implicitly (for example through a cyclic redundancy check overlay) provide information regarding the PPDU being an EHT PPDU.

In the case of an EHT PPDU 1100 according to the third embodiment, the EHT-SIG 0 field 1112 immediately follows L-SIG, and thus there is no RL-SIG as there would be in 802.11ax. The EHT-SIG 0 field may have the same number of tones as an 802.11ax L-SIG field, that is 48 data tones, 4 pilot tones, and 4 extra tones. It is to be noted that the 4 extra tones were added to the L-SIG in 802.11ax, and were not present in the L-SIG field prior to 802.11ax. As shown in FIG. 11, the EHT-SIG 0 may be in non-HT duplicate format, duplicate onto respective 20 MHz bandwidths of the PPDU. Similar to 802.11ax, the 4 extra tones 1103 of each EHT-SIG 0 field may be used as training tones for training a receiver of the EHT PPDU 1100. In addition, or in the alternative, 4 extra tones (or edge tones, e.g. guard tones) may be used in the L-SIG field 1110 as training tones for training the receiver of the EHT PPDU 1100. An EHT PPDU 1100 that encodes 4 extra tones/4 edge tones in both the EHT-SIG 0 field 1112 and the L-SIG field 1110 would advantageously allow a more robust training of the receiver of the EHT STA receiving the PPDU. In addition to including information regarding an identity of the PPDU being an EHT PPDU, the EHT SIG 0 field 1112 may include bandwidth indication to indicate information regarding the PPDU bandwidth, such that a receiver of an EHT STA receiving the EHT PPDU can perform enhanced decoding of the EHT-SIG 1 and EHT-SIG 2 fields. For example, the EHT-SIG 0 field 1112 may indicate that the EHT-SIG 1 and EHT-SIG 2 fields are encoded across multiple 20 MHz channels in duplicate format (not shown), or, in the alternative, that the EHT-SIG 1 and EHT-SIG 2 fields 1114 and 1116 are encoded across the whole bandwidth.

According to one embodiment, the bits in the EHT-SIG 0 field 1112 may be organized as follows: a number of encoded bits, for example 4 bits, for bandwidth indication; a number of encoded bits, for example 8 bits, for CRC; a number of encoded bits, for example 6 bits, for the EHT signature (i.e. for an explicit indication that the PPDU is an EHT PPDU) and other indications; and a number of encoded bits, for example 6 bits, for a binary convolutional code (BCC) tail.

According to one embodiment, the EHT-SIG 0 field 1112 may use both explicit signaling by way of encoded bits to indicate the EHT signature, and by way of implicit signaling, such as through a CRC overlay onto the encoded CRC bits of the EHT-SIG 0 field 1112.

While FIGS. 8, 10 and 11 depict respective embodiments for a format of a EHT PPDU in the time and frequency domains, FIGS. 12, 13 and 14 are respective flowcharts depicting, respectively, the processing stages to process some or all of the EHT PPDU according to the first, second and third embodiments respectively, the processing stages having been schematically depicted for each of an operation associated with a non-HT procedure (non-HT STA), a HT procedure (HT STA), a VHT procedure (VHT STA), a HE procedure (HE STA) and an EHT procedure (EHT STA). In each of FIGS. 12, 13 and 14, with respect to the shown processing stages of the EHT

PPDU by a EHT STA, it is assumed that an EHT STA is an addressee of the EHT PPDU, either explicitly such as through a SU or a MU PPDU, or implicitly such as by way of a EHT that has been broadcast by the AP.

Referring first to FIG. 12, a flowchart 1200 is shown depicting the processing stages to process a EHT PPDU according to the first embodiment (denoted “Option 1” in FIG. 12) such as EHT PPDU 800 of FIG. 8. In the ensuring description, reference will be made to the elements of FIGS. 8 and 12 concurrently, and the FIG. referred to will be clear from the first digit(s) of the reference numeral (“8” for FIG. 8 and “12” for FIG. 12).

As shown in FIG. 12, where a non-HT STA receives at 1204 an EHT PPDU according to Option 1, the non-HT STA would at 1214 demodulate the L-SIG 810 since the L-SIG is a legacy signal field apt to be demodulated by a non-HT (802.11 a or 802.11g) STA. The non-HT STA would at 1214 determine the CRC for the L-SIG to be valid, and would assume that it can now go ahead and decode the PPDU, which it does at 1216. However, because the PPDU is EHT PPDU (as opposed to a non-HT PPDU), the CRC would fail at 1220. Thereafter, the non-HT STA would know at 1222 to defer any further transmissions based on the expected length of the EHT PPDU as decoded from L-SIG 810.

Referring still to FIG. 12, where a HT STA receives, at 1206, an EHT PPDU according to Option 1, the HT STA would at 1223 demodulate the L-SIG field 810 since the L-SIG field is a legacy signal field apt to be demodulated by a HT (802.11n) STA. The HT STA would at 1223 determine the CRC for the L-SIG field to be valid. Next, the HT STA would determine at 1224 the constellation of the first symbol after the L-SIG field 810, that is, the constellation of -RL-SIG field 812. An HT-STA would be looking for a constellation of the first symbol after L-SIG field 810 that is QBPSK. Since -RL-SIG field 812 is BPSK, similar to L-SIG field 810, the HT-STA would at 1226, assume the PPDU is a non-HT PPDU, and would, because it is backward compatible, engage its non-HT functionality by moving onto process stage 1216 to decode the PPDU. Ensuing processing stages would then involve stages 1220 and 1222 as described above with respect to the operation of a non-HT STA.

Where a VHT STA receives, at 1208, an EHT PPDU according to Option 1, the VHT STA would at 1209 demodulate the L-SIG field 810 since the L-SIG field is a legacy signal field apt to be demodulated by a VHT (802.11n) STA. The VHT STA would at 1209 determine the CRC for the L-SIG field to be valid. Next, the VHT STA would determine at 1228 the constellation of the first symbol and of the second symbol after the L-SIG field 810, that is, the constellation of -RL-SIG field 812 and of EHT-SIG 1 field 814. A VHT-STA would be looking for a constellation of the first symbol after the L-SIG field that is BPSK, and of the second symbol after the L-SIG field that is QBPSK. Since -RL-SIG field 812 is BPSK, similar to L-SIG field 810, and since EHT-SIG 1 is QBPSK, the VHT-STA would at 1230, assume the PPDU is a VHT PPDU, and would therefore assume that the -RL-SIG field is a VHT-SIG A1 field and that the EHT-SIG 1 field 814 is a VHT-SIG A2 field. Having determined the constellations as such, the VHT STA would at 1232 decode the first symbol and the second symbol (-RL-SIG and EHT-SIG 1 fields) after the L-SIG field as VHT-SIG A1 and VHT-SIG A2. In doing so, the CRC for the latter decoding would fail at 1220, and the VHT STA would then defer transmissions based on a length of the PPDU as inferred from the L-SIG field at 1222.

Where a HE STA receives, at 1210, an EHT PPDU according to Option 1, the HE STA would at 1211 demodulate the L-SIG field 810 since the L-SIG field is a legacy signal field apt to be demodulated by a HE (802.11ax) STA. The HE STA would at 1211 determine the CRC for the L-SIG field to be valid. Next, the HE STA would determine at 1234 that the first symbol after the L-SIG field 810, that is, -RL-SIG field 812, is not an exact duplicate of the L-SIG field, and would then, at 1236, assume the PPDU is a VHT PPDU. At this time, the HE STA would move over to stage 1228, 1230, 1232, 1220 and 1222 as described above in relation to the VHT STA.

Where an EHT STA receives, at 1212, an EHT PPDU according to Option 1, the EHT STA would at 1215 demodulate the L-SIG field 810 since the L-SIG field is a legacy signal field apt to be demodulated by a EHT STA. The EHT STA would at 1215 determine the CRC for the L-SIG field to be valid. Next, the HE STA would determine at 1238 that the first symbol after the L-SIG field 810, that is, -RL-SIG field 812, is not an exact duplicate of the L-SIG field 810, possibly also determining that the -RL-SIG field 812 is a reverse polarity duplicate of the L-SIG field 810. Stage 1238 may, according to one embodiment, be enough for the EHT STA to determine the PPDU to be an EHT PPDU, at which point it would at 1242 decode other symbols within the EHT PPDU. If the EHT PPDU is addressed to the EHT STA (for example, either explicitly by way of the EHT STA address or identification having been decoded in the EHT SIG field, or implicitly by way of the EHT PPDU for example being a broadcast PPDU), the EHT STA may at 1244 decode the entirety of the EHT PPDU. According to one embodiment, for a more reliable identification of the PPDU as an EHT PPDU, the EHT STA could, at 1240, determine the second symbol after the L-SIG field (EHT-SIG 1) as having a QBPSK constellation, and the third symbol after the L-SIG field (EHT-SIG 2) as having a BPSK constellation, before moving onto stage 1242 and stage 1244.

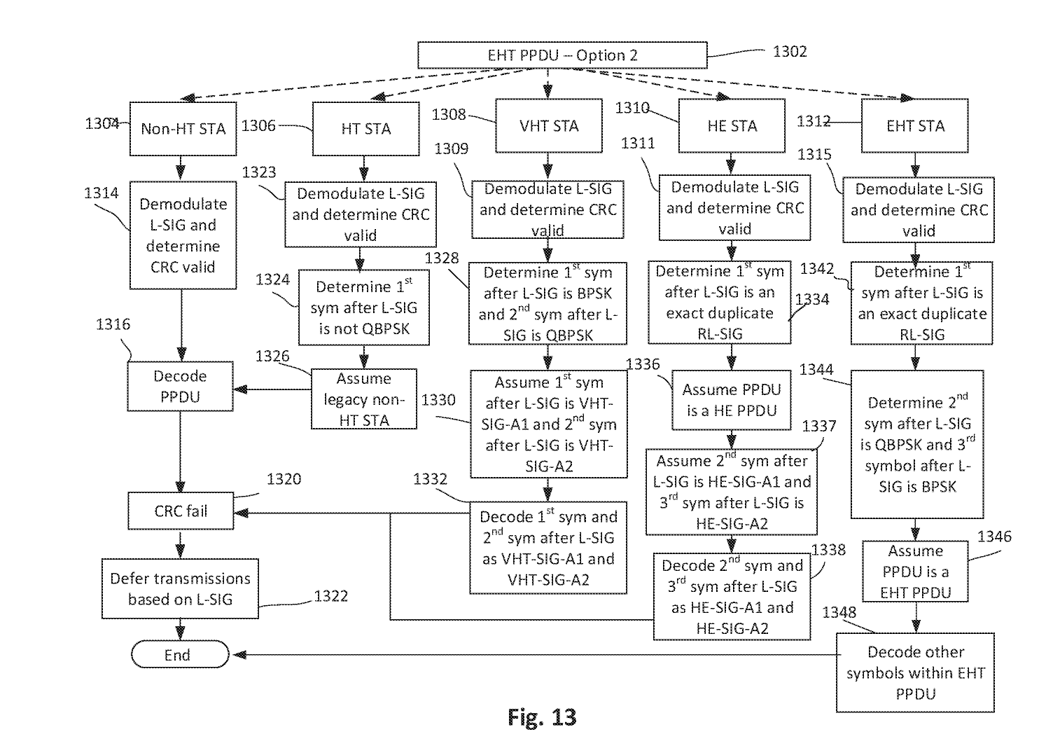

Reference will now be made to the flowchart of FIG. 13, which depicts a flowchart 1200 showing the processing stages to process a EHT PPDU according to the second embodiment (denoted “Option 2” in FIG. 13) such as EHT PPDU 1000 of FIG. 10. In the ensuring description, reference will be made to the elements of FIGS. 10 and 13 concurrently, and the FIG. referred to will be clear from the first digit(s) of the reference numeral (“10” for FIG. 10 and “13” for FIG. 13).

FIG. 13 differs from FIG. 12 only in the process stages corresponding to the HE STA and EHT STA processing of the EHT PPDU according to Option 1. The process stages 1304, 1314, 1316, 1320, 1322, 1306, 1323, 1324, 1326, 1308, 1309, 1328, 1330, and 1332 correspond, respectively, to the process stages 1204, 1214, 1216, 1220, 1222, 1206, 1223, 1224, 1226, 1208, 1209, 1228, 1230, and 1232 as described in the paragraphs above with respect to FIG. 12, and will therefore not be described in detail in relation to FIG. 13. In essence, a non-HT STA, a HT STA and a VHT STA would process an EHT PPDU according to Option 2 in the same way that they would process an EHT PPDU according to Option 1.

Referring then to FIG. 13, where a HE STA receives, at 1310, an EHT PPDU according to Option 2, the HE STA would at 1311 demodulate the L-SIG field 1010 since the L-SIG field is a legacy signal field apt to be demodulated by a HE (802.11ax) STA. The HE STA would at 1311 determine the CRC for the L-SIG field to be valid. Next, the HE STA would determine at 1334 that the first symbol after the L-SIG field 1010, that is, RL-SIG field 1012, is an exact duplicate of the L-SIG field, and would then, at 1336, assume the PPDU is a HE PPDU. The HE STA would then at 1337 assume the second symbol after the L-SIG field (EHT-SIG 1) and the third symbol after the L-SIG field (EHT-SIG 2) correspond to HE-SIG A1 and HE-SIG A2 in 802.11ax respectively, and would attempt to decode these two symbols at 1338. At this time, the HE STA would move over to stage 1320 because of a failed CRC.

Where an EHT STA receives, at 1312, an EHT PPDU according to Option 2, the EHT STA would at 1315 demodulate the L-SIG field 1010 since the L-SIG field is a legacy signal field apt to be demodulated by a EHT STA. The EHT STA would at 1315 determine the CRC for the L-SIG field to be valid. Next, the HE STA would determine at 1342 that the first symbol after the L-SIG field 1010, that is, RL-SIG field 1012, is an exact duplicate of the L-SIG field 1010. The EHT STA would then, at 1344, determine that the second symbol after the L-SIG field is QBPSK modulated, and the third symbol after the L-SIG field is BPSK modulated. This would allow the EHT STA to identify the PPDU at a EHT PPDU at 1346. At 1348, the EHT STA would decode other symbols within the EHT PPDU. If the EHT PPDU is addressed to the EHT STA (for example, either explicitly by way of the EHT STA address or identification having been decoded in the EHT SIG field, or implicitly by way of the EHT PPDU for example being a broadcast PPDU), the EHT STA may at 1348 decode the entirety of the EHT PPDU.

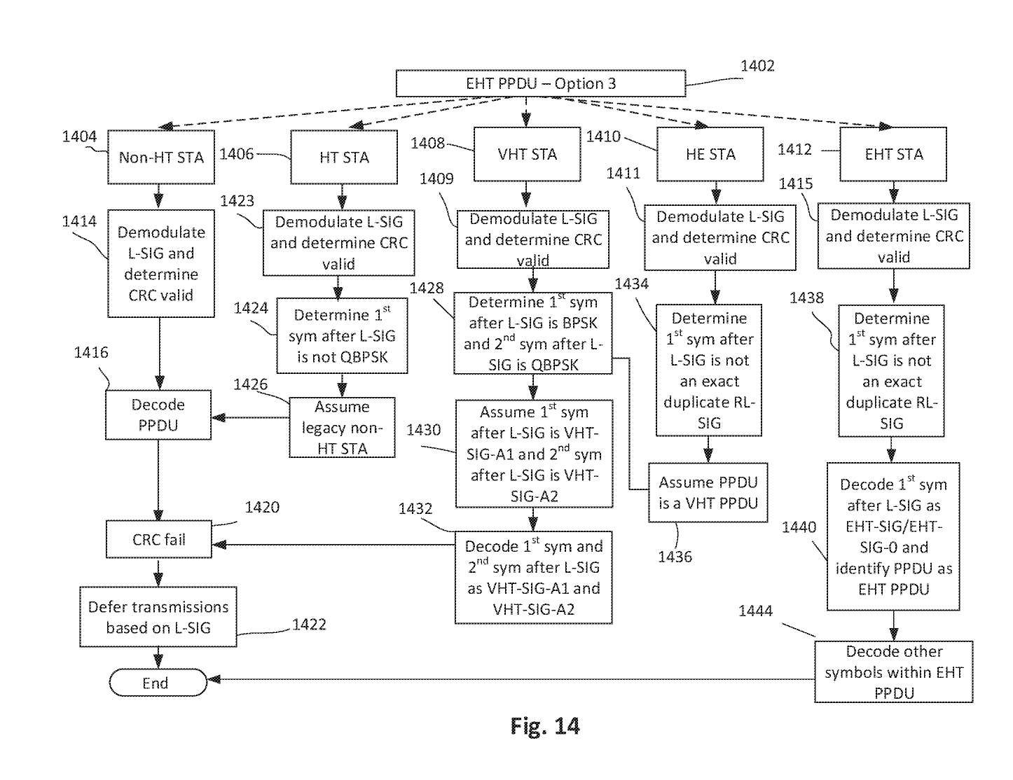

Reference will now be made to the flowchart of FIG. 14. FIG. 14 differs from FIG. 12 only in the process stages corresponding to the HE STA and EHT STA processing of the EHT PPDU according to Option 1. The process stages 1404, 1414, 1416, 1420, 1422, 1406, 1423, 1424, 1426, 1408, 1409, 1428, 1430, and 1432 correspond, respectively, to the process stages 1204, 1214, 1216, 1220, 1222, 1206, 1223, 1224, 1226, 1208, 1209, 1228, 1230, and 1232 as described in the paragraphs above with respect to FIG. 12, and will therefore not be described in detail in relation to FIG. 14. In essence, a non-HT STA, a HT STA and a VHT STA would process an EHT PPDU according to Option 3 in the same way that they would process an EHT PPDU according to Options 1 and 2.

FIG. 14 depicts a flowchart 1400 showing the processing stages to process a EHT PPDU according to the second embodiment (denoted “Option 3” in FIG. 14) such as EHT PPDU 1100 of FIG. 11. In the ensuring description, reference will be made to the elements of FIGS. 11 and 14 concurrently, and the FIG. referred to will be clear from the first digit(s) of the reference numeral (“11” for FIG. 11 and “14” for FIG. 14).

Referring then to FIG. 14, where a HE STA receives, at 1410, an EHT PPDU according to Option 3, the HE STA would at 1411 demodulate the L-SIG field 1110 since the L-SIG field is a legacy signal field apt to be demodulated by a HE (802.11ax) STA. The HE STA would at 1411 determine the CRC for the L-SIG field to be valid. Next, the HE STA would determine at 1434 that the first symbol after the L-SIG field 1110, that is, EHT-SIG 0 field 1112, is not an exact duplicate of the L-SIG field, and would then, at 1436, assume the PPDU is a VHT PPDU. At this time, the HE STA would move over to stage 1428, 1430, 1432, 1420 and 1422 as described above in relation to the VHT STA.

Where an EHT STA receives, at 1412, an EHT PPDU according to Option 2, the EHT STA would at 1415 demodulate the L-SIG field 1110 since the L-SIG field is a legacy signal field apt to be demodulated by a EHT STA. The EHT STA would at 1415 determine the CRC for the L-SIG field to be valid. Next, the HE STA would determine at 1438 that the first symbol after the L-SIG field 1110, that is, EHT-SIG 0 1112, is not an exact duplicate of the L-SIG field 1110. The EHT STA would then, at 1440, decode the first symbol after the L-SIG field, that is, EHT-SIG 0 1112 and identify the PPDU as an EHT PPDU based on EHT-SIG 0. At 1444, the EHT STA would decode other symbols within the EHT PPDU. If the EHT PPDU is addressed to the EHT STA (for example, either explicitly by way of the EHT STA address or identification having been decoded in the EHT SIG field, or implicitly by way of the EHT PPDU for example being a broadcast PPDU), the EHT STA may at 1448 decode the entirety of the EHT PPDU.

Regarding the flow charts of FIGS. 12-14, a “legacy device” would include devices that are compliant with 802.11a/g/n/ac/ax (non-HT STA, HT STA, VHT STA and HE STA). It is further to be understood in the context of FIGS. 12-14 that, if the device detecting the EHT PPDU is the HE STA, it would perform a typical receive procedure for a HE STA, examples of which are described in the IEEE 802.11ax/D3.0 specification at FIGS. 28-58 through 28-62, and at the exemplary state machine at FIG. 28-62. Some exemplary stages of such a receive procedure are shown at a high level in FIGS. 12-14. By way of another example, if the device detecting the EHT

PPDU is the HT STA, it would perform a typical receive procedure for a HT STA, examples of which are described in the IEEE 802.11-2016 specification at FIGS. 19-25, 19-26 and at the exemplary state machine at FIG. 19-27. Some exemplary stages of such a receive procedure are shown at a high level in FIGS. 12-14. Thus, FIGS. 12-14 are merely to illustrate, at a high level, stages of processing of a EHT PPDU that is formatted according to embodiments, without necessarily limiting the order in which those stages are performed, as long as typical receive procedures associated with each of 802.11a/g/n/ac/ax are performed as noted above. In the same context, it is further to be understood in the context of FIGS. 12-14 that any given STA shown would be backward compatible and able to perform stages of a receive procedure for prior iterations of the protocol with which it is compliant. For example, the HE STA would be backwards compatible and would be able to perform the receive procedures shown with respect to a non-HT STA, a HT STA and a VHT STA, as would be understood by a person skilled in the art.

The first, second and third embodiments advantageously allow a VHT STA and a HE STA to perform early termination (ET) of decoding (e.g. by avoiding decoding of the whole PPDU, such as by processing at least parts of the legacy and EHT preamble without decoding the entire PPDU). In this way, a VHT STA and a HE STA would receive the preambles of the EHT PPDU, but not decode the whole packet, in this way saving power.

With respect to ET, referring first to FIG. 12: a VHT STA would be able to perform ET after decoding the first and second symbols after the L-SIG field at 1232, at which time CRC would fail at 1220, leading to ET; a HE STA would be able to perform ET after processing the first symbol after the L-SIG field at 1234, and then decoding the first symbol and the second symbol after the L-SIG field at 1232, at which time, again CRC would fail at 1220, leading to ET.

With respect to ET, referring to FIG. 13, similar to the embodiment of FIG. 12, a VHT STA would be able to perform ET after decoding the first and second symbols after the L-SIG field at 1332, at which time CRC would fail at 1320, leading to ET; a HE STA would be able to perform ET after decoding the first symbol after the L-SIG field at 1334, and then decoding the second symbol and the third symbol after the L-SIG field at 1337, at which time, again CRC would fail at 1320, leading to ET.

Unlike the first embodiments as depicted in FIG. 12, which first embodiment: (1) allows the HE STA to perform ET after decoding the first symbol and the second symbol after the L-SIG field at 1232, and (2) allows the EHT STA to identify the PPDU as a EHT PPDU after processing of the first symbol after the L-SIG field at 1238 (since processing the EHT-SIG 1 field would be optional under the first embodiment), the second embodiment as depicted in FIG. 13: (1) requires the HE STA to process the first symbol after the L-SIG field, and decode the second and third symbols after the L-SIG field before being able to perform ET at 1338; and (2) allows the EHT STA to identify the PPDU as a EHT PPDU only after processing the first symbol after the L-SIG field, and also processing at least the second symbol after the L-SIG field at 1344. Therefore, in the second embodiment, it can take longer than in the first embodiment for a VHT STA to perform ET and for a EHT STA to identify the PPDU as a EHT PPDU.

Similar to the first embodiment as depicted in FIG. 12, the third embodiment as depicted in FIG. 14: (1) allows the HE STA to perform ET after decoding the first symbol and the second symbol after the L-SIG field at 1432, and (2) allows the EHT STA to identify the PPDU as a EHT PPDU using the first symbol after the L-SIG field at 1438 and 1440. However, the third embodiment leads to a slight delay in the identification of an EHT PPDU by an EHT STA, in that, in addition to requiring a processing of the first symbol after the L-SIG field, it requires a decoding of the symbol at 1440. The third embodiment is different from the first embodiment in that it allows additional information signaling in a EHT-SIG 0 field that is part of the EHT PPDU's EHT SIG field, the additional information including for example bandwidth information regarding the EHT PPDU, and training tones for the receiver of the EHT STA to receive the EHT PPDU. The third embodiment therefore allows a more robust manner of EHT PPDU signaling while further allowing the possibility of choosing the channelization of the EHT SIG field.

Some benefits of the third embodiment include: (1) an ability to provide early bandwidth indication such that the decoding performance of the EHT-SIG field including EHT-SIG 0, EHT-SIG 1 and EHT-SIG 2 can be significantly improved for larger bandwidth; (2) use of an EHT signature can be extended into further generations of the standard to signal and allow autodetection of further generation PPDUs; and (3) the ability to provide information in the EHT-SIG 0 to indicate other common information for EHT PPDU.

In addition to the above advantages, some embodiments provide EHT PPDU configurations that offer sufficient ways to differentiate EHT PPDU types. For example, EHT may provide three or four or more PPDU types, such as single user (SU) PPDU, MU PPDU, trigger-based (TB) PPDU, and extended range (ER) PPDU. According to some embodiments, the LENTH field (in L-SIG) modulus 3 could be used to indicate two states (remainder=1 or 2 as signaling two states/modes), and/or the modulation scheme of the EHT-SIG 2 field (e.g. BPSK or QBPSK) could be used to signal two (additional) modes/and/or a bit in the EHT-SIG field, such as in the EHT-SIG 0 field, could be used to signal two (additional) modes as well.

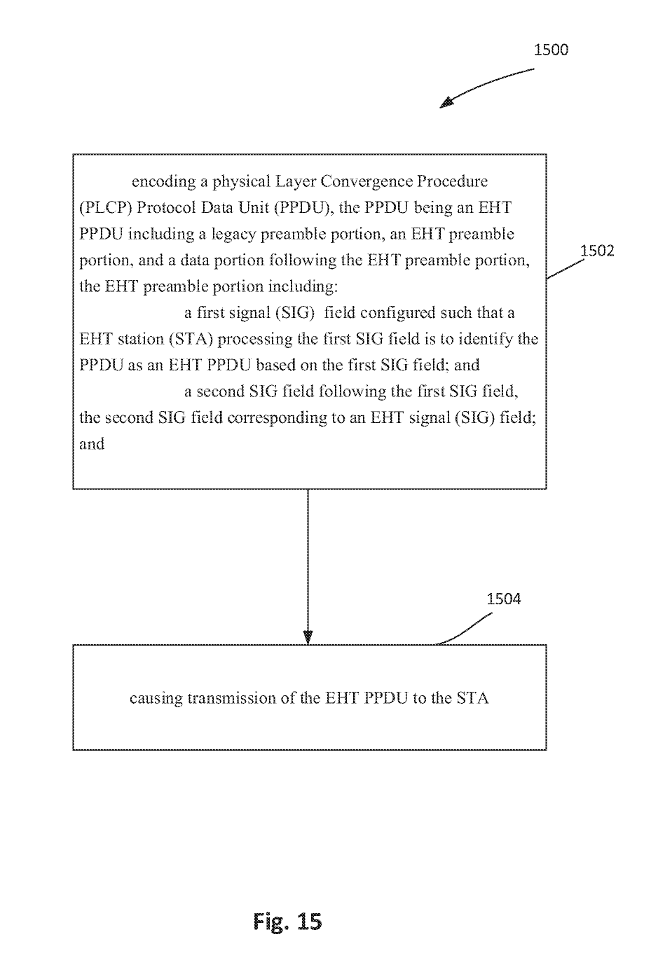

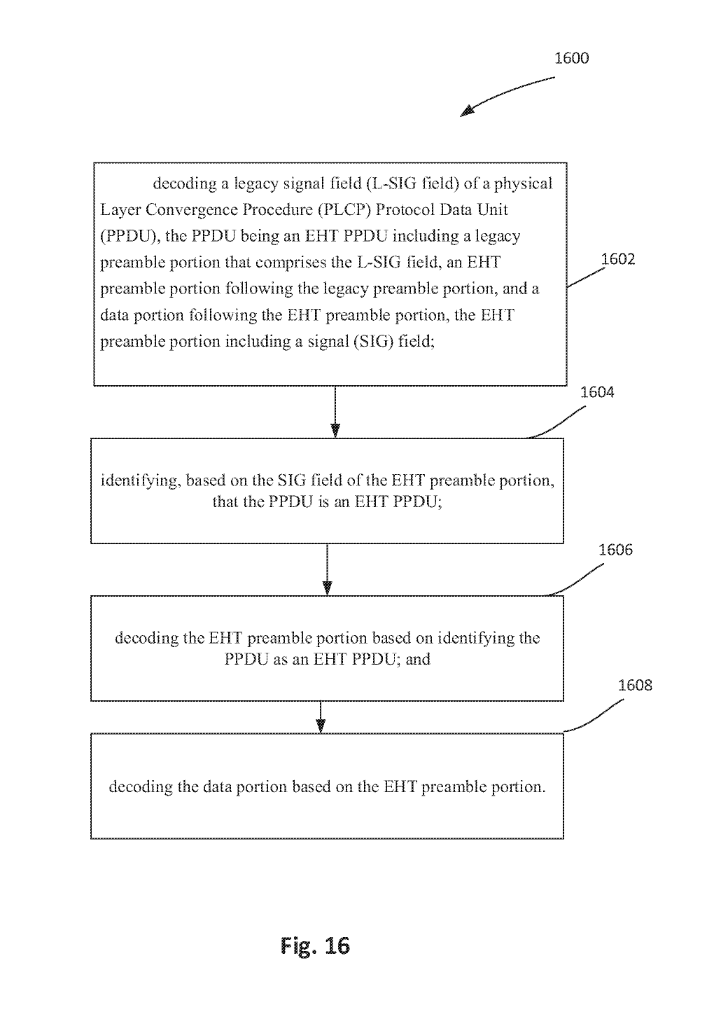

FIGS. 15 and 16 depict two method according to some embodiments.

As seen in FIG. 15, a first method embodiment 1500 includes, at operation 1502 encoding a physical Layer Convergence Procedure (PLCP) Protocol Data Unit (PPDU), the PPDU being an EHT PPDU including a legacy preamble portion, an EHT preamble portion, and a data portion following the EHT preamble portion, the EHT preamble portion including: a first signal (SIG) field configured such that a EHT station (STA) processing the first SIG field is to identify the PPDU as an EHT PPDU based on the first SIG field; and a second SIG field following the first SIG field, the second SIG field corresponding to an EHT signal (SIG) field. At operation 1504, the method includes causing transmission of the EHT PPDU to an EHT PPDU.

As seen in FIG. 16, a first method embodiment 1600 includes, at operation 1602 decoding a legacy signal field (L-SIG field) of a physical Layer Convergence Procedure (PLCP) Protocol Data Unit (PPDU), the PPDU being an EHT PPDU including a legacy preamble portion that comprises the L-SIG field, an EHT preamble portion following the legacy preamble portion, and a data portion following the EHT preamble portion, the EHT preamble portion including a signal (SIG) field. At operation 1604, the method includes identifying, based on the SIG field of the EHT preamble portion, that the PPDU is an EHT PPDU. At operation 1606, the method includes decoding the EHT preamble portion based on identifying the PPDU as an EHT PPDU. At operation 1608, the method includes decoding the data portion based on the EHT preamble portion.

The following first examples pertain to further embodiments.

Example 1 includes a wireless communication device of a first Extremely High Throughput (EHT) wireless station (STA), the device comprising physical layer (PHY layer) circuitry and Medium Access Control layer (MAC) layer circuitry connected to the PHY layer circuitry, the PHY layer circuitry including logic to: encode a physical Layer Convergence Procedure (PLCP) Protocol Data Unit (PPDU), the PPDU being an EHT PPDU including a legacy preamble portion, an EHT preamble portion, and a data portion following the EHT preamble portion, the EHT preamble portion including: a first signal (SIG) field configured such that a second EHT station (STA) processing the first SIG field is to identify the PPDU as an EHT PPDU based on the first SIG field; and a second SIG field following the first SIG field, the second SIG field corresponding to an EHT signal (SIG) field; and cause transmission of the EHT PPDU to the second EHT STA.

Example 2 includes the subject matter of Example 1, and optionally, wherein the legacy preamble portion includes a legacy SIG field (L-SIG field) and the first SIG field includes a repeated L-SIG field (RL-SIG field) immediately following the L-SIG field, the RL-SIG field including one of an exact duplicate of the L-SIG field or a duplicate of the L-SIG field except for a polarity of the RL-SIG being reversed with respect to a polarity of the L-SIG field.

Example 3 includes the subject matter of Example 1, and optionally, wherein the EHT SIG field includes a first EHT SIG field EHT-SIG1 and a second EHT SIG field EHT-SIG 2, EHT-SIG 1 being modulated using Quadrature Binary Phase Shift Keying (QBPSK) modulation, and EHT-SIG 2 being modulated using Binary Phase Shift Keying (BPSK) modulation.

Example 4 includes the subject matter of Example 3, and optionally, wherein the EHT-SIG 1 field and the EHT-SIG 2 field are each in one of a non-high-throughput (non-HT) duplicate format or encoded across an entire bandwidth of the EHT PPDU.

Example 5 includes the subject matter of Example 1, and optionally, wherein: the legacy preamble portion includes a legacy SIG field (L-SIG field); the first SIG field and the second SIG field both correspond to the EHT SIG field, the first SIG field including an EHT-SIG 0 field, and the second SIG field including an EHT-SIG 1 field and an EHT-SIG 2 field; the EHT-SIG 0 field includes information that, when decoded by the second EHT STA, indicates the PPDU to be an EHT PPDU.

Example 6 includes the subject matter of Example 5, and optionally, wherein the EHT-SIG 0 field is to be in non-high-throughput (non-HT) duplicate format.

Example 7 includes the subject matter of Example 6, and optionally, wherein the EHT-SIG 1 and the EHT-SIG 2 fields are encoded across an entire bandwidth of the EHT PPDU.

Example 8 includes the subject matter of Example 5, and optionally, wherein the information includes one of an explicit signaling by way of a signature including encoded bits, or implicit signaling.

Example 9 includes the subject matter of Example 8, and optionally, wherein the information includes explicit signaling by way of a signature including encoded bits, the EHT-SIG 0 further including encoded bits to indicate a bandwidth of the PPDU.

Example 10 includes the subject matter of Example 8, and optionally, wherein the information includes implicit signaling, the EHT-SIG 0 includes cyclic redundancy check (CRC) bits, and the information includes a CRC overlay on the CRC bits.

Example 11 includes the subject matter of Example 5, and optionally, wherein the EHT-SIG 0 field includes a same number of tones as the L-SIG field including 48 data tones, 4 pilot tones and 4 edge tones, the PHY layer circuitry to configure the 4 edge tones of the EHT-SIG 0 field as training tones to train a receiver of the second EHT STA.

Example 12 includes the subject matter of Example 10, and optionally, wherein the L-SIG includes 4 edge tones, the PHY layer circuitry to configure the 4 edge tones of the L-SIG as additional training tones to train the receiver of the second EHT STA.

Example 13 includes the subject matter of Example 1, and optionally, wherein the EHT PPDU further includes EHT training fields following the EHT SIG field.

Example 14 includes the subject matter of Example 12, and optionally, wherein the EHT PPDU is a multi-user multiple-input multiple-output (MU-MIMO) EHT PPDU and further includes a EHT SIG B field following the EHT SIG field and followed by the EHT training fields.

Example 15 includes the subject matter of Example 1, and optionally, further including a radio integrated circuit coupled to the PHY circuitry and the MAC circuitry, and a front-end module coupled to the radio integrated circuit.

Example 16 includes the subject matter of Example 15, and optionally, further including one or more antennas coupled to the front-end module, the antennas to transmit the EHT PPDU.

Example 17 includes a product comprising one or more tangible computer-readable non-transitory storage media comprising computer-executable instructions operable to, when executed by at least one computer processor, enable the at least one computer processor to implement operations at a wireless communication device of a first Extremely High Throughput (EHT) wireless station (STA), the operations comprising: encoding a physical Layer Convergence Procedure (PLCP) Protocol Data Unit (PPDU), the PPDU being an EHT PPDU including a legacy preamble portion, an EHT preamble portion, and a data portion following the EHT preamble portion, the EHT preamble portion including: a first signal (SIG) field configured such that a second EHT station (STA) processing the first SIG field is to identify the PPDU as an EHT PPDU based on the first SIG field; and a second SIG field following the first SIG field, the second SIG field corresponding to an EHT signal (SIG) field; and causing transmission of the EHT PPDU to the second EHT STA.

Example 18 includes the subject matter of Example 17, and optionally, wherein the legacy preamble portion includes a legacy SIG field (L-SIG field) and the first SIG field includes a repeated L-SIG field (RL-SIG field) immediately following the L-SIG field, the RL-SIG field including one of an exact duplicate of the L-SIG field or a duplicate of the L-SIG field except for a polarity of the RL-SIG being reversed with respect to a polarity of the L-SIG field.

Example 19 includes the subject matter of Example 17, and optionally, wherein the EHT SIG field includes a first EHT SIG field EHT-SIG1 and a second EHT SIG field EHT-SIG 2, EHT-SIG 1 being modulated using Quadrature Binary Phase Shift Keying (QBPSK) modulation, and EHT-SIG 2 being modulated using Binary Phase Shift Keying (BPSK) modulation.

Example 20 includes the subject matter of Example 19, and optionally, wherein the EHT-SIG 1 field and the EHT-SIG 2 field are each in one of a non-high-throughput (non-HT) duplicate format or encoded across an entire bandwidth of the EHT PPDU.

Example 21 includes the subject matter of Example 17, and optionally, wherein: the legacy preamble portion includes a legacy SIG field (L-SIG field); the first SIG field and the second SIG field both correspond to the EHT SIG field, the first SIG field including an EHT-SIG 0 field, and the second SIG field including an EHT-SIG 1 field and an EHT-SIG 2 field; and the EHT-SIG 0 field includes information that, when decoded by the second EHT STA, indicates the PPDU to be an EHT PPDU.

Example 22 includes the subject matter of Example 21, and optionally, wherein the EHT-SIG 0 field is to be in non-high-throughput (non-HT) duplicate format.

Example 23 includes the subject matter of Example 22, and optionally, wherein the EHT-SIG 1 and the EHT-SIG 2 fields are encoded across an entire bandwidth of the EHT PPDU.

Example 24 includes the subject matter of Example 21, and optionally, wherein the information includes one of an explicit signaling by way of a signature including encoded bits, or implicit signaling.

Example 25 includes the subject matter of Example 24, and optionally, wherein the information includes explicit signaling by way of a signature including encoded bits, the EHT-SIG 0 further including encoded bits to indicate a bandwidth of the PPDU.

Example 26 includes the subject matter of Example 24, and optionally, wherein the information includes implicit signaling, the EHT-SIG 0 includes cyclic redundancy check (CRC) bits, and the information includes a CRC overlay on the CRC bits.

Example 27 includes the subject matter of Example 21, and optionally, wherein the EHT-SIG 0 field includes a same number of tones as the L-SIG field including 48 data tones, 4 pilot tones and 4 edge tones, the operations further including configuring the 4 edge tones of the EHT-SIG 0 field as training tones to train a receiver of the second EHT STA.

Example 28 includes the subject matter of Example 26, and optionally, wherein the L-SIG includes 4 edge tones, the operations further including configuring the 4 edge tones of the L-SIG as additional training tones to train the receiver of the second EHT STA.

Example 29 includes the subject matter of Example 17, and optionally, wherein the EHT PPDU further includes EHT training fields following the EHT SIG field.

Example 30 includes the subject matter of Example 28, and optionally, wherein the EHT PPDU is a multi-user multiple-input multiple-output (MU-MIMO) EHT PPDU and further includes a EHT SIG B field following the EHT SIG field and followed by EHT training fields.

Example 31 includes a method to be performed by a wireless communication device of a first Extremely High Throughput (EHT) wireless station (STA), the method comprising: encoding a physical Layer Convergence Procedure (PLCP) Protocol Data Unit (PPDU), the PPDU being an EHT PPDU including a legacy preamble portion, an EHT preamble portion, and a data portion following the EHT preamble portion, the EHT preamble portion including: a first signal (SIG) field configured such that a second EHT station (STA) processing the first SIG field is to identify the PPDU as an EHT PPDU based on the first SIG field; and a second SIG field following the first SIG field, the second SIG field corresponding to an EHT signal (SIG) field; and causing transmission of the EHT PPDU to the second EHT STA.

Example 32 includes the subject matter of Example 31, and optionally, wherein the legacy preamble portion includes a legacy SIG field (L-SIG field) and the first SIG field includes a repeated L-SIG field (RL-SIG field) immediately following the L-SIG field, the RL-SIG field including one of an exact duplicate of the L-SIG field or a duplicate of the L-SIG field except for a polarity of the RL-SIG being reversed with respect to a polarity of the L-SIG field.

Example 33 includes the subject matter of Example 31, and optionally, wherein the EHT SIG field includes a first EHT SIG field EHT-SIG1 and a second EHT SIG field EHT-SIG 2, EHT-SIG 1 being modulated using Quadrature Binary Phase Shift Keying (QBPSK) modulation, and EHT-SIG 2 being modulated using Binary Phase Shift Keying (BPSK) modulation.

Example 34 includes the subject matter of Example 33, and optionally, wherein the EHT-SIG 1 field and the EHT-SIG 2 field are each in one of a non-high-throughput (non-HT) duplicate format or encoded across an entire bandwidth of the EHT PPDU.

Example 35 includes the subject matter of Example 31, and optionally, wherein: the legacy preamble portion includes a legacy SIG field (L-SIG field); the first SIG field and the second SIG field both correspond to the EHT SIG field, the first SIG field including an EHT-SIG 0 field, and the second SIG field including an EHT-SIG 1 field and an EHT-SIG 2 field; and the EHT-SIG 0 field includes information that, when decoded by the second EHT STA, indicates the PPDU to be an EHT PPDU.

Example 36 includes the subject matter of Example 35, and optionally, wherein the EHT-SIG 0 field is to be in non-high-throughput (non-HT) duplicate format.

Example 37 includes the subject matter of Example 36, and optionally, wherein the EHT-SIG 1 and the EHT-SIG 2 fields are encoded across an entire bandwidth of the EHT PPDU.

Example 38 includes the subject matter of Example 35, and optionally, wherein the information includes one of an explicit signaling by way of a signature including encoded bits, or implicit signaling.

Example 39 includes the subject matter of Example 38, and optionally, wherein the information includes explicit signaling by way of a signature including encoded bits, the EHT-SIG 0 further including encoded bits to indicate a bandwidth of the PPDU.

Example 40 includes the subject matter of Example 38, and optionally, wherein the information includes implicit signaling, the EHT-SIG 0 includes cyclic redundancy check (CRC) bits, and the information includes a CRC overlay on the CRC bits.

Example 41 includes the subject matter of Example 35, and optionally, wherein the EHT-SIG 0 field includes a same number of tones as the L-SIG field including 48 data tones, 4 pilot tones and 4 edge tones, the method including configuring the 4 edge tones of the EHT-SIG 0 field as training tones to train a receiver of the second EHT STA.

Example 42 includes the subject matter of Example 40, and optionally, wherein the L-SIG includes 4 edge tones, the method including configuring the 4 edge tones of the L-SIG as additional training tones to train the receiver of the second EHT STA.

Example 43 includes the subject matter of Example 31, and optionally, wherein the EHT PPDU further includes EHT training fields following the EHT SIG field.

Example 44 includes the subject matter of Example 42, and optionally, wherein the EHT PPDU is a multi-user multiple-input multiple-output (MU-MIMO) EHT PPDU and further includes a EHT SIG B field following the EHT SIG field and followed by EHT training fields.

Example 45 includes a wireless communication device of a first Extremely High Throughput (EHT) wireless station (STA), the device including: means for encoding a physical Layer Convergence Procedure (PLCP) Protocol Data Unit (PPDU), the PPDU being an EHT PPDU including a legacy preamble portion, an EHT preamble portion, and a data portion following the EHT preamble portion, the EHT preamble portion including: a first signal (SIG) field configured such that a second EHT station (STA) processing the first SIG field is to identify the PPDU as an EHT PPDU based on the first SIG field; and a second SIG field following the first SIG field, the second SIG field corresponding to an EHT signal (SIG) field; and means for causing transmission of the EHT PPDU to the second EHT STA.

Example 46 includes the subject matter of Example 45, and optionally, wherein the legacy preamble portion includes a legacy SIG field (L-SIG field) and the first SIG field includes a repeated L-SIG field (RL-SIG field) immediately following the L-SIG field, the RL-SIG field including one of an exact duplicate of the L-SIG field or a duplicate of the L-SIG field except for a polarity of the RL-SIG being reversed with respect to a polarity of the L-SIG field.

Example 47 includes the subject matter of Example 45, and optionally, wherein the EHT SIG field includes a first EHT SIG field EHT-SIG1 and a second EHT SIG field EHT-SIG 2, EHT-SIG 1 being modulated using Quadrature Binary Phase Shift Keying (QBPSK) modulation, and EHT-SIG 2 being modulated using Binary Phase Shift Keying (BPSK) modulation.

Example 48 includes the subject matter of Example 47, and optionally, wherein the EHT-SIG 1 field and the EHT-SIG 2 field are each in one of a non-high-throughput (non-HT) duplicate format or encoded across an entire bandwidth of the EHT PPDU.

Example 49 includes the subject matter of Example 45, and optionally, wherein: the legacy preamble portion includes a legacy SIG field (L-SIG field); the first SIG field and the second SIG field both correspond to the EHT SIG field, the first SIG field including an EHT-SIG 0 field, and the second SIG field including an EHT-SIG 1 field and an EHT-SIG 2 field; the EHT-SIG 0 field includes information that, when decoded by the second EHT STA, indicates the PPDU to be an EHT PPDU.

Example 50 includes a wireless device of an Extremely High Throughput (EHT) wireless station (STA), the device comprising physical layer (PHY layer) circuitry and Medium Access Control layer (MAC) layer circuitry connected to the PHY layer circuitry, the PHY layer circuitry including logic to: decode a legacy signal field (L-SIG field) of a physical Layer Convergence Procedure (PLCP) Protocol Data Unit (PPDU), the PPDU being an EHT PPDU including a legacy preamble portion that comprises the L-SIG field, an EHT preamble portion following the legacy preamble portion, and a data portion following the EHT preamble portion, the EHT preamble portion including a signal (SIG) field; identify, based on the SIG field of the EHT preamble portion, that the PPDU is an EHT PPDU; decode the EHT preamble portion based on identifying the PPDU as an EHT PPDU; and decode the data portion based on the EHT preamble portion.

Example 51 includes the subject matter of Example 50, and optionally, wherein the SIG field of the EHT preamble portion is a first SIG field, the EHT preamble portion further including a second SIG field following the first SIG field, the second SIG field corresponding to an EHT signal (SIG) field.

Example 52 includes the subject matter of Example 50, and optionally, wherein: the legacy preamble portion includes a legacy SIG field (L-SIG field) and the first SIG field includes a repeated L-SIG field (RL-SIG field) immediately following the L-SIG field, the RL-SIG field including one of an exact duplicate of the L-SIG field or a duplicate of the L-SIG field except for a polarity of the RL-SIG being reversed with respect to a polarity of the L-SIG field; and the PHY layer circuitry is further configured to decode the L-SIG field and to one of: determine whether the first SIG field includes a RL-SIG field that is an exact duplicate of the L-SIG field; or determine whether the first SIG field includes a RL-SIG field that is a duplicate of the L-SIG field except for a polarity of the RL-SIG being reversed with respect to a polarity of the L-SIG field.

Example 53 includes the subject matter of Example 50, and optionally, wherein: the EHT SIG field includes a first EHT SIG field EHT-SIG 1 and a second EHT SIG field EHT-SIG 2, EHT-SIG 1 being modulated using Quadrature Binary Phase Shift Keying (QBPSK) modulation, and EHT-SIG 2 being modulated using Binary Phase Shift Keying (BPSK) modulation; and the PHY layer circuitry is further configured to determine a constellation of at least one of the EHT-SIG 1 field and the EHT-SIG 2 field and to identify the PPDU as an EHT PPDU based on the constellation.

Example 54 includes the subject matter of Example 53, and optionally, wherein: the EHT-SIG 1 field and the EHT-SIG 2 field are each in one of a non-high-throughput (non-HT) duplicate format or encoded across an entire bandwidth of the EHT PPDU; and the PHY layer circuitry is to decode the EHT-SIG 1 field and the EHT-SIG 2 field based on identifying the PPDU as an EHT PPDU.

Example 55 includes the subject matter of Example 51, and optionally, wherein: the legacy preamble portion includes a legacy SIG field (L-SIG field); the first SIG field and the second SIG field both correspond to the EHT SIG field, the first SIG field including an EHT-SIG 0 field, and the second SIG field including an EHT-SIG 1 field and an EHT-SIG 2 field, the EHT-SIG 0 field including information to indicate an EHT PPDU; the PHY layer circuitry is to decode the EHT-SIG 0 field to extract the information to identify the PPDU as an EHT PPDU.

Example 56 includes the subject matter of Example 55, and optionally, wherein the EHT-SIG 0 field is to be in non-high-throughput (non-HT) duplicate format.

Example 57 includes the subject matter of Example 56, and optionally, wherein the EHT-SIG 1 and the EHT-SIG 2 fields are encoded across an entire bandwidth of the EHT PPDU.

Example 58 includes the subject matter of Example 55, and optionally, wherein the information includes one of an explicit signaling by way of a signature including encoded bits, or implicit signaling.

Example 59 includes the subject matter of Example 58, and optionally, wherein the information includes explicit signaling by way of a signature including encoded bits, the EHT-SIG 0 further including encoded bits to indicate a bandwidth of the PPDU.

Example 60 includes the subject matter of Example 58, and optionally, wherein the information includes implicit signaling, the EHT-SIG 0 includes cyclic redundancy check (CRC) bits, and the information includes a CRC overlay on the CRC bits.

Example 61 includes the subject matter of Example 55, and optionally, wherein the EHT-SIG 0 field includes a same number of tones as the L-SIG field including 48 data tones, 4 pilot tones and 4 edge tones, the PHY layer circuitry to process the 4 edge tones of the EHT-SIG 0 field as training tones for the EHT STA.

Example 62 includes the subject matter of Example 61, and optionally, wherein the L-SIG includes 4 edge tones, the PHY layer circuitry to process the 4 edge tones of the L-SIG as additional training tones to train the EHT STA.

Example 63 includes the subject matter of Example 51, and optionally, wherein the EHT PPDU further includes EHT training fields following the EHT SIG field, and wherein the PHY layer circuitry is to decode the training fields to train the EHT STA.

Example 64 includes the subject matter of Example 62, and optionally, wherein: the EHT PPDU is a multi-user multiple-input multiple-output (MU-MIMO) EHT PPDU and further includes a EHT-SIG B field following the EHT SIG field and followed by the EHT training fields; and the PHY layer circuitry is to decode the EHT-SIG B field and to decode a remainder of the EHT PPDU based on the EHT-SIG B field.

Example 65 includes the subject matter of Example 51, and optionally, further including a radio integrated circuit coupled to the PHY circuitry and the MAC circuitry, and a front-end module coupled to the radio integrated circuit.

Example 66 includes the subject matter of Example 65, and optionally, further including one or more antennas coupled to the front-end module, the antennas to transmit the EHT PPDU.

Example 67 includes a product comprising one or more tangible computer-readable non-transitory storage media comprising computer-executable instructions operable to, when executed by at least one computer processor, enable the at least one computer processor to implement operations at a wireless communication device of an extremely high throughput (EHT) station (STA), the operations comprising: decoding a legacy signal field (L-SIG field) of a physical Layer Convergence Procedure (PLCP) Protocol Data Unit (PPDU), the PPDU being an EHT PPDU including a legacy preamble portion that comprises the L-SIG field, an EHT preamble portion following the legacy preamble portion, and a data portion following the EHT preamble portion, the EHT preamble portion including a signal (SIG) field; identifying, based on the SIG field of the EHT preamble portion, that the PPDU is an EHT PPDU; decoding the EHT preamble portion based on identifying the PPDU as an EHT PPDU; and decoding the data portion based on the EHT preamble portion.

Example 68 includes the subject matter of Example 67, and optionally, wherein the SIG field of the EHT preamble portion is a first SIG field, the EHT preamble portion further including a second SIG field following the first SIG field, the second SIG field corresponding to an EHT signal (SIG) field.

Example 69 includes the subject matter of Example 67, and optionally, wherein: the legacy preamble portion includes a legacy SIG field (L-SIG field) and the first SIG field includes a repeated L-SIG field (RL-SIG field) immediately following the L-SIG field, the RL-SIG field including one of an exact duplicate of the L-SIG field or a duplicate of the L-SIG field except for a polarity of the RL-SIG being reversed with respect to a polarity of the L-SIG field; and the operations further include decoding the L-SIG field and one of: determining whether the first SIG field includes a RL-SIG field that is an exact duplicate of the L-SIG field; or determining whether the first SIG field includes a RL-SIG field that is a duplicate of the L-SIG field except for a polarity of the RL-SIG being reversed with respect to a polarity of the L-SIG field.

Example 70 includes the subject matter of Example 67, and optionally, wherein: the EHT SIG field includes a first EHT SIG field EHT-SIG 1 and a second EHT SIG field EHT-SIG 2, EHT-SIG 1 being modulated using Quadrature Binary Phase Shift Keying (QBPSK) modulation, and EHT-SIG 2 being modulated using Binary Phase Shift Keying (BPSK) modulation; and the operations further include determining a constellation of at least one of the EHT-SIG 1 field and the EHT-SIG 2 field and to identify the PPDU as an EHT PPDU based on the constellation.

Example 71 includes the subject matter of Example 70, and optionally, wherein: the EHT-SIG 1 field and the EHT-SIG 2 field are each in one of a non-high-throughput (non-HT) duplicate format or encoded across an entire bandwidth of the EHT PPDU; and the operations further include decoding the EHT-SIG 1 field and the EHT-SIG 2 field based on identifying the PPDU as an EHT PPDU.

Example 72 includes the subject matter of Example 68, and optionally, wherein: the legacy preamble portion includes a legacy SIG field (L-SIG field); the first SIG field and the second SIG field both correspond to the EHT SIG field, the first SIG field including an EHT-SIG 0 field, and the second SIG field including an EHT-SIG 1 field and an EHT-SIG 2 field, the EHT-SIG 0 field including information to indicate an EHT PPDU; the operations further include decoding the EHT-SIG 0 field to extract the information to identify the PPDU as an EHT PPDU.

Example 73 includes the subject matter of Example 72, and optionally, wherein the EHT-SIG 0 field is to be in non-high-throughput (non-HT) duplicate format.

Example 74 includes the subject matter of Example 73, and optionally, wherein the EHT-SIG 1 and the EHT-SIG 2 fields are encoded across an entire bandwidth of the EHT PPDU.

Example 75 includes the subject matter of Example 72, and optionally, wherein the information includes one of an explicit signaling by way of a signature including encoded bits, or implicit signaling.

Example 76 includes the subject matter of Example 75, and optionally, wherein the information includes explicit signaling by way of a signature including encoded bits, the EHT-SIG 0 further including encoded bits to indicate a bandwidth of the PPDU.

Example 77 includes the subject matter of Example 75, and optionally, wherein the information includes implicit signaling, the EHT-SIG 0 includes cyclic redundancy check (CRC) bits, and the information includes a CRC overlay on the CRC bits.

Example 78 includes the subject matter of Example 72, and optionally, wherein the EHT-SIG 0 field includes a same number of tones as the L-SIG field including 48 data tones, 4 pilot tones and 4 edge tones, the operations further include processing the 4 edge tones of the EHT-SIG 0 field as training tones for the EHT STA.

Example 79 includes the subject matter of Example 78, and optionally, wherein the L-SIG includes 4 edge tones, the operations further including processing the 4 edge tones of the L-SIG as additional training tones to train the EHT STA.

Example 80 includes the subject matter of Example 68, and optionally, wherein the EHT PPDU further includes EHT training fields following the EHT SIG field, and wherein the operations further include decoding the training fields to train the EHT STA.

Example 81 includes the subject matter of Example 68, and optionally, wherein: the EHT PPDU is a multi-user multiple-input multiple-output (MU-MIMO) EHT PPDU and further includes a EHT-SIG B field following the EHT SIG field and followed by the EHT training fields; and the operations further include decoding the EHT-SIG B field and to decode a remainder of the EHT PPDU based on the EHT-SIG B field.

Example 82 includes the method to be performed by a wireless communication device of an extremely high throughput (EHT) station (STA), the method including: decoding a legacy signal field (L-SIG field) of a physical Layer Convergence Procedure (PLCP) Protocol Data Unit (PPDU), the PPDU being an EHT PPDU including a legacy preamble portion that comprises the L-SIG field, an EHT preamble portion following the legacy preamble portion, and a data portion following the EHT preamble portion, the EHT preamble portion including a signal (SIG) field; identifying, based on the SIG field of the EHT preamble portion, that the PPDU is an EHT PPDU; decoding the EHT preamble portion based on identifying the PPDU as an EHT PPDU; and decoding the data portion based on the EHT preamble portion.

Example 83 includes the subject matter of Example 82, and optionally, wherein the SIG field of the EHT preamble portion is a first SIG field, the EHT preamble portion further including a second SIG field following the first SIG field, the second SIG field corresponding to an EHT signal (SIG) field.

Example 84 includes the subject matter of Example 82, and optionally, wherein: the legacy preamble portion includes a legacy SIG field (L-SIG field) and the first SIG field includes a repeated L-SIG field (RL-SIG field) immediately following the L-SIG field, the RL-SIG field including one of an exact duplicate of the L-SIG field or a duplicate of the L-SIG field except for a polarity of the RL-SIG being reversed with respect to a polarity of the L-SIG field; and the method further includes decoding the L-SIG field and one of: determining whether the first SIG field includes a RL-SIG field that is an exact duplicate of the L-SIG field; or determining whether the first SIG field includes a RL-SIG field that is a duplicate of the L-SIG field except for a polarity of the RL-SIG being reversed with respect to a polarity of the L-SIG field.

Example 85 includes the subject matter of Example 82, and optionally, wherein: the EHT SIG field includes a first EHT SIG field EHT-SIG 1 and a second EHT SIG field EHT-SIG 2, EHT-SIG 1 being modulated using Quadrature Binary Phase Shift Keying (QBPSK) modulation, and EHT-SIG 2 being modulated using Binary Phase Shift Keying (BPSK) modulation; and the method further includes determining a constellation of at least one of the EHT-SIG 1 field and the EHT-SIG 2 field and to identify the PPDU as an EHT PPDU based on the constellation.

Example 86 includes the subject matter of Example 85, and optionally, wherein: the EHT-SIG 1 field and the EHT-SIG 2 field are each in one of a non-high-throughput (non-HT) duplicate format or encoded across an entire bandwidth of the EHT PPDU; and the method further includes decoding the EHT-SIG 1 field and the EHT-SIG 2 field based on identifying the PPDU as an EHT PPDU.

Example 87 includes the subject matter of Example 83, and optionally, wherein: the legacy preamble portion includes a legacy SIG field (L-SIG field); the first SIG field and the second SIG field both correspond to the EHT SIG field, the first SIG field including an EHT-SIG 0 field, and the second SIG field including an EHT-SIG 1 field and an EHT-SIG 2 field, the EHT-SIG 0 field including information to indicate an EHT PPDU; the method further includes decoding the EHT-SIG 0 field to extract the information to identify the PPDU as an EHT PPDU.

Example 88 includes the subject matter of Example 87, and optionally, wherein the EHT-SIG 0 field is to be in non-high-throughput (non-HT) duplicate format.

Example 89 includes the subject matter of Example 88, and optionally, wherein the EHT-SIG 1 and the EHT-SIG 2 fields are encoded across an entire bandwidth of the EHT PPDU.

Example 90 includes the subject matter of Example 87, and optionally, wherein the information includes one of an explicit signaling by way of a signature including encoded bits, or implicit signaling.

Example 91 includes the subject matter of Example 90, and optionally, wherein the information includes explicit signaling by way of a signature including encoded bits, the EHT-SIG 0 further including encoded bits to indicate a bandwidth of the PPDU.

Example 92 includes the subject matter of Example 90, and optionally, wherein the information includes implicit signaling, the EHT-SIG 0 includes cyclic redundancy check (CRC) bits, and the information includes a CRC overlay on the CRC bits.

Example 93 includes the subject matter of Example 87, and optionally, wherein the EHT-SIG 0 field includes a same number of tones as the L-SIG field including 48 data tones, 4 pilot tones and 4 edge tones, the method further includes processing the 4 edge tones of the EHT-SIG 0 field as training tones for the EHT STA.

Example 94 includes the subject matter of Example 93, and optionally, wherein the L-SIG includes 4 edge tones, the operations further including processing the 4 edge tones of the L-SIG as additional training tones to train the EHT STA.

Example 95 includes the subject matter of Example 83, and optionally, wherein the EHT PPDU further includes EHT training fields following the EHT SIG field, and wherein the method further includes decoding the training fields to train the EHT STA.

Example 96 includes the subject matter of Example 79, and optionally, wherein: the EHT PPDU is a multi-user multiple-input multiple-output (MU-MIMO) EHT PPDU and further includes a EHT-SIG B field following the EHT SIG field and followed by the EHT training fields; and the method further includes decoding the EHT-SIG B field and to decode a remainder of the EHT PPDU based on the EHT-SIG B field.

Example 97 includes a wireless communication device of an extremely high throughput (EHT) station (STA), the device including: means for decoding a legacy signal field (L-SIG field) of a physical Layer Convergence Procedure (PLCP) Protocol Data Unit (PPDU), the PPDU being an EHT PPDU including a legacy preamble portion that comprises the L-SIG field, an EHT preamble portion following the legacy preamble portion, and a data portion following the EHT preamble portion, the EHT preamble portion including a signal (SIG) field; means for identifying, based on the SIG field of the EHT preamble portion, that the PPDU is an EHT PPDU; means for decoding the EHT preamble portion based on identifying the PPDU as an EHT PPDU; and means for decoding the data portion based on the EHT preamble portion.

Example 98 includes the subject matter of Example 97, and optionally, wherein the SIG field of the EHT preamble portion is a first SIG field, the EHT preamble portion further including a second SIG field following the first SIG field, the second SIG field corresponding to an EHT signal (SIG) field.

Example 99 includes the subject matter of Example 97, and optionally, wherein: the legacy preamble portion includes a legacy SIG field (L-SIG field) and the first SIG field includes a repeated L-SIG field (RL-SIG field) immediately following the L-SIG field, the RL-SIG field including one of an exact duplicate of the L-SIG field or a duplicate of the L-SIG field except for a polarity of the RL-SIG being reversed with respect to a polarity of the L-SIG field; and the device further includes means for decoding the L-SIG field and one of: means for determining whether the first SIG field includes a RL-SIG field that is an exact duplicate of the L-SIG field; or means for determining whether the first SIG field includes a RL-SIG field that is a duplicate of the L-SIG field except for a polarity of the RL-SIG being reversed with respect to a polarity of the L-SIG field.

Example 100 includes the subject matter of Example 97, and optionally, wherein: the EHT SIG field includes a first EHT SIG field EHT-SIG 1 and a second EHT SIG field EHT-SIG 2, EHT-SIG 1 being modulated using Quadrature Binary Phase Shift Keying (QBPSK) modulation, and EHT-SIG 2 being modulated using Binary Phase Shift Keying (BPSK) modulation; and the device further includes means for determining a constellation of at least one of the EHT-SIG 1 field and the EHT-SIG 2 field and to identify the PPDU as an EHT PPDU based on the constellation.

Example 101 includes the subject matter of Example 100, and optionally, wherein: the EHT-SIG 1 field and the EHT-SIG 2 field are each in one of a non-high-throughput (non-HT) duplicate format or encoded across an entire bandwidth of the EHT PPDU; and the device further includes means for decoding the EHT-SIG 1 field and the EHT-SIG 2 field based on identifying the PPDU as an EHT PPDU.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A wireless communication device of a first Extremely High Throughput (EHT) wireless station (STA), the device comprising physical layer (PHY layer) circuitry and Medium Access Control layer (MAC) layer circuitry connected to the PHY layer circuitry, the PHY layer circuitry including logic to:
encode a physical Layer Convergence Procedure (PLCP) Protocol Data Unit (PPDU), the PPDU being an EHT PPDU including a legacy preamble portion, an EHT preamble portion, and a data portion following the EHT preamble portion, the EHT preamble portion including:
a first signal (SIG) field configured such that a second EHT station (STA) processing the first SIG field is to identify the PPDU as an EHT PPDU based on the first SIG field; and
a second SIG field following the first SIG field, the second SIG field corresponding to an EHT signal (SIG) field; and
cause transmission of the EHT PPDU to the second EHT STA.

2. The device of claim 1, wherein the legacy preamble portion includes a legacy SIG field (L-SIG field) and the first SIG field includes a repeated L-SIG field (RL-SIG field) immediately following the L-SIG field, the RL-SIG field including one of an exact duplicate of the L-SIG field or a duplicate of the L-SIG field except for a polarity of the RL-SIG being reversed with respect to a polarity of the L-SIG field.

3. The device of claim 1, wherein the EHT SIG field includes a first EHT SIG field EHT-SIG1 and a second EHT SIG field EHT-SIG 2, EHT-SIG 1 being modulated using Quadrature Binary Phase Shift Keying (QBPSK) modulation, and EHT-SIG 2 being modulated using Binary Phase Shift Keying (BPSK) modulation.

4. The device of claim 3, wherein the EHT-SIG 1 field and the EHT-SIG 2 field are each in one of a non-high-throughput (non-HT) duplicate format or encoded across an entire bandwidth of the EHT PPDU.

5. The device of claim 1, wherein:
the legacy preamble portion includes a legacy SIG field (L-SIG field);
the first SIG field and the second SIG field both correspond to the EHT SIG field, the first SIG field including an EHT-SIG 0 field, and the second SIG field including an EHT-SIG 1 field and an EHT-SIG 2 field; and
the EHT-SIG 0 field includes information that, when decoded by the second EHT STA, indicates the PPDU to be an EHT PPDU.

6. The device of claim 5, wherein the EHT-SIG 0 field is to be in non-high-throughput (non-HT) duplicate format.

7. The device of claim 6, wherein the EHT-SIG land the EHT-SIG 2 fields are encoded across an entire bandwidth of the EHT PPDU.

8. The device of claim 5, wherein the information includes explicit signaling by way of a signature including encoded bits, the EHT-SIG 0 further including encoded bits to indicate a bandwidth of the PPDU.

9. The device of claim 5, wherein the information includes implicit signaling, the EHT-SIG 0 includes cyclic redundancy check (CRC) bits, and the information includes a CRC overlay on the CRC bits.

10. The device of claim 5, wherein the EHT-SIG 0 field includes a same number of tones as the L-SIG field including 48 data tones, 4 pilot tones and 4 edge tones, the PHY layer circuitry to configure the 4 edge tones of the EHT-SIG 0 field as training tones to train a receiver of the second EHT STA.

11. The device of claim 10, wherein the L-SIG includes 4 edge tones, the PHY layer circuitry to configure the 4 edge tones of the L-SIG as additional training tones to train the receiver of the second EHT STA.

12. The device of claim 1, further including a radio integrated circuit coupled to the PHY circuitry and the MAC circuitry, and a front-end module coupled to the radio integrated circuit.

13. The device of claim 12, further including one or more antennas coupled to the front-end module, the antennas to transmit the EHT PPDU.

14. A product comprising one or more tangible computer-readable non-transitory storage media comprising computer-executable instructions operable to, when executed by at least one computer processor, enable the at least one computer processor to implement operations at a wireless communication device of a first Extremely High Throughput (EHT) wireless station (STA), the operations comprising:
encoding a physical Layer Convergence Procedure (PLCP) Protocol Data Unit (PPDU), the PPDU being an EHT PPDU including a legacy preamble portion, an EHT preamble portion, and a data portion following the EHT preamble portion, the EHT preamble portion including:
a first signal (SIG) field configured such that a second EHT station (STA) processing the first SIG field is to identify the PPDU as an EHT PPDU based on the first SIG field; and
a second SIG field following the first SIG field, the second SIG field corresponding to an EHT signal (SIG) field; and
causing transmission of the EHT PPDU to the second EHT STA.

15. The product of claim 14, wherein the legacy preamble portion includes a legacy SIG field (L-SIG field) and the first SIG field includes a repeated L-SIG field (RL-SIG field) immediately following the L-SIG field, the RL-SIG field including one of an exact duplicate of the L-SIG field or a duplicate of the L-SIG field except for a polarity of the RL-SIG being reversed with respect to a polarity of the L-SIG field.

16. The product of claim 14, wherein the EHT SIG field includes a first EHT SIG field EHT-SIG1 and a second EHT SIG field EHT-SIG 2, EHT-SIG 1 being modulated using Quadrature Binary Phase Shift Keying (QBPSK) modulation, and EHT-SIG 2 being modulated using Binary Phase Shift Keying (BPSK) modulation.

17. The product of claim 14, wherein:
the legacy preamble portion includes a legacy SIG field (L-SIG field);
the first SIG field and the second SIG field both correspond to the EHT SIG field, the first SIG field including an EHT-SIG 0 field, and the second SIG field including an EHT-SIG 1 field and an EHT-SIG 2 field; and
the EHT-SIG 0 field includes information that, when decoded by the second EHT STA, indicates the PPDU to be an EHT PPDU.

18. The product of claim 17, wherein the information includes explicit signaling by way of a signature including encoded bits, the EHT-SIG 0 further including encoded bits to indicate a bandwidth of the PPDU.

19. The product of claim 17, wherein the information includes implicit signaling, the EHT-SIG 0 includes cyclic redundancy check (CRC) bits, and the information includes a CRC overlay on the CRC bits.

20. The product of claim 17, wherein the EHT-SIG 0 field includes a same number of tones as the L-SIG field including 48 data tones, 4 pilot tones and 4 edge tones, the operations further including configuring the 4 edge tones of the EHT-SIG 0 field as training tones to train a receiver of the second EHT STA.

21. A method to be performed by a wireless communication device of a first Extremely High Throughput (EHT) wireless station (STA), the method comprising:
encoding a physical Layer Convergence Procedure (PLCP) Protocol Data Unit (PPDU), the PPDU being an EHT PPDU including a legacy preamble portion, an EHT preamble portion, and a data portion following the EHT preamble portion, the EHT preamble portion including:
a first signal (SIG) field configured such that a second EHT station (STA) processing the first SIG field is to identify the PPDU as an EHT PPDU based on the first SIG field; and
a second SIG field following the first SIG field, the second SIG field corresponding to an EHT signal (SIG) field; and
causing transmission of the EHT PPDU to the second EHT STA.

22. The method of claim 21, wherein the EHT SIG field includes a first EHT SIG field EHT-SIG1 and a second EHT SIG field EHT-SIG 2, EHT-SIG 1 being modulated using Quadrature Binary Phase Shift Keying (QBPSK) modulation, and EHT-SIG 2 being modulated using Binary Phase Shift Keying (BPSK) modulation.

23. The method of claim 21, wherein:
the legacy preamble portion includes a legacy SIG field (L-SIG field);
the first SIG field and the second SIG field both correspond to the EHT SIG field, the first SIG field including an EHT-SIG 0 field, and the second SIG field including an EHT-SIG 1 field and an EHT-SIG 2 field; and
the EHT-SIG 0 field includes information that, when decoded by the second EHT STA, indicates the PPDU to be an EHT PPDU, the information including at least one of an explicit signaling by way of a signature including encoded bits, or implicit signaling.

24. A wireless communication device of a first Extremely High Throughput (EHT) wireless station (STA), the device including:
means for encoding a physical Layer Convergence Procedure (PLCP) Protocol Data Unit (PPDU), the PPDU being an EHT PPDU including a legacy preamble portion, an EHT preamble portion, and a data portion following the EHT preamble portion, the EHT preamble portion including:
a first signal (SIG) field configured such that a second EHT station (STA) processing the first SIG field is to identify the PPDU as an EHT PPDU based on the first SIG field; and
a second SIG field following the first SIG field, the second SIG field corresponding to an EHT signal (SIG) field; and
means for causing transmission of the EHT PPDU to the second EHT STA.

25. The device of claim 24, wherein:
the legacy preamble portion includes a legacy SIG field (L-SIG field);
the first SIG field and the second SIG field both correspond to the EHT SIG field, the first SIG field including an EHT-SIG 0 field, and the second SIG field including an EHT-SIG 1 field and an EHT-SIG 2 field; and
the EHT-SIG 0 field includes information that, when decoded by the second EHT STA, indicates the PPDU to be an EHT PPDU.
